(19) United States
(12) Patent Application Publication
(10) Pub. No.: US 2017/0057838 A1
(43) Pub. Date: Mar. 2, 2017

(54) WATER CAPPING OF TAILINGS

(71) Applicant: SYNCRUDE CANADA LTD. in trust for the owners of the Syncrude Project as such owners exist now and, Fort McMurray (CA)

(72) Inventors: MICHAEL MacKINNON, Hamilton (CA); HANS BOERGER, Parksville (CA); WARREN ZUBOT, Edmonton (CA)

(21) Appl. No.: 14/836,612

(22) Filed: Aug. 26, 2015

(51) Int. Cl. C02F 1/24; C02F 1/00

(52) U.S. Cl. CPC C02F 1/24; C02F 1/004; C02F 2103/10

(57) ABSTRACT

A method of reclamation using tailings produced during oil sands extraction processes involves depositing tailings below grade into a pit, the tailings comprising a solids content of at least about 30 wt % with greater than about 60% of the solids being fines; placing a layer of water of sufficient depth and volume over the deposit of tailings; and allowing densification of the tailings to occur without mechanical or chemical intervention, wherein the layer of water capping the tailings deposit forms a lake habitable for plants and animals.

### FIELD OF THE INVENTION

The present invention relates generally to a method of reclamation of tailings using water capping. The invention is particularly useful with, but not limited to, fluid fine tailings (FFT) produced during oil sands extraction processes.

### BACKGROUND OF THE INVENTION

Oil sand generally comprises water-wet sand grains held together by a matrix of viscous heavy oil or bitumen. Bitumen is a complex and viscous mixture of large or heavy hydrocarbon molecules which contain a significant amount of sulfur, nitrogen and oxygen. The extraction of bitumen from sand using hot water processes yields large volumes of tailings composed of fine silts, clays and residual bitumen which have to be contained in a tailings pond. Mineral fractions with a particle diameter less than 44 microns are referred to as “fines.” These fines are typically quartz and clay mineral suspensions, predominantly kaolinite and illite.

The fine tailings suspension is typically 85 wt % water and 15 wt % fine particles by volume. Dewatering of fine tailings occurs very slowly. When first discharged in the pond, the very low density material is referred to as thin fine tailings. After a few years when the fine tailings have reached a solids content of about 30-35 wt %, they are sometimes referred to as mature fine tailings (MFT). The volumes of MFT produced are substantial, at about 0.05-0.1 m³ per tonne of oil sand processed. Unaided MFT densification to fully-consolidated clay has been projected to take hundreds of years. Further, MFT is not strong enough to support a load equivalent to large road or earthmoving equipment, and is therefore classed as “soft” or “non-trafficable.” Hereinafter, the more general term of fluid fine tailings (FFT) which encompasses the spectrum of tailings from discharge to final settled state will be used. The FFT behave as a fluid colloidal-like material. The fact that FFT behave as a fluid and have very slow consolidation rates limits options to reclaim tailings ponds. A challenge facing the industry remains the removal of water from the FFT to increase the solids content well beyond 35 wt % and strengthen the deposits to the point that they can be reclaimed and no longer require containment.

Water capped tailings technology is a cost effective means to reclaim FFT and oil sands process water, and to integrate an aquatic landform in the closure landscape. Water capped tailings technology includes placing water over tailings materials in an end-pit to create a relatively shallow lake in the closure landscape.

However, research and monitoring of a full scale demonstration of water capped tailings technology have not been conducted to validate the technology as a reclamation option. Further, conventional outflow systems to remove water from tailings ponds typically involve use of siphon systems or floating barges equipped with pumps to source water at depths of about two meters below the surface of the tailings pond. However, such systems fail to remove stagnant water and floatable materials including, for example, bitumen, hydrocarbon sheens, oil films, fine mineral solids which do not readily settle, foams, emulsions, and debris such as plastic, wood, or the like. These materials negatively impact water quality, waterfowl, wildlife, and aesthetics; increase emission of volatile organic compounds and turbidity; and reduce oxygen transfer, surface evaporation, and light penetration in littoral zones impacting lake ecology.

### SUMMARY OF THE INVENTION

The present invention relates to a method of reclamation using tailings and water capping. The invention is particularly useful with, but not limited to, fluid fine tailings (FFT) produced during oil sands extraction processes. It was surprisingly discovered that by using the method of the present invention, one or more of the following benefits may be realized:

(1) The method enables natural remediation of tailings and oil sands process water (OSPW) to a release quality through natural degradation and dilution with lake inflow waters. The filling of end-pits with OSPW reduces the need for fresh water and allows development of higher trophic levels for final reclamation.

(2) Sufficient mixing of the OSPW within the free water zone provides adequate dissolved oxygen for degradation of organic material and development of biological life without re-suspension of the tailings. Further, the method allows long term, low energy densification of tailings without requiring mechanical intervention or chemical addition.

(3) Tailings having a solids content of at least about 30 wt % with greater than about 60% of the solids being fines, remain undisturbed by wind when the lake dimensions are designed to eliminate the possibility of tailings mixing, for example, when the depth of the water capping layer is equal to or greater than about 5 meters, and the fetch is less than about 4 km.

(4) The natural biodegradation process of naphthenic acids would passively treat the naphthenic acids and other organics released from the consolidation water.

(5) The chemical composition of the groundwater is reasonable similar to the pore water, thus, released pore water influx into the groundwater is not a concern.

(6) Acute toxicity does not persist in the water capping layer and will dissipate within the 1^{st} two years. Chronic toxicity due to elevated concentrations of salinity is dependent on the free water residence time and typically diminishes over the first ten years from inception.

(7) Littoral zone development, and particularly rooted plant growth, is strongly related to sediment quality of the shoreline.

(8) Ecosystem development in experimental test ponds suggests water capped lakes can provide a suitable habitat for native plants and animals, within the range of diversity and productivity observed for lakes in the region.

Thus, broadly stated, in one aspect of the present invention, a method of reclamation using tailings produced during oil sands extraction processes is provided, comprising:
depositing tailings below grade into a pit, the tailings comprising a solids content of at least about 30 wt % with greater than about 60% of the solids comprising fines;
placing a layer of water of sufficient depth and volume over the deposit of tailings; and
allowing densification of the tailings to occur without mechanical or chemical intervention, wherein the layer of water capping the tailings deposit forms a lake habitable for plants and animals.

As used herein, “pit” refers to any depression or hole in the ground such as a mine-out pit, a quarry, a crater, a trench and the like or an above-ground structure.

In one embodiment, the tailings comprises fluid fine tailings (FFT). In another embodiment, the tailings comprises treated tailings, e.g., tailings that have been subjected to centrifugation, filtration, gravity separation, or accelerated dewatering in a dewatering pit.

In one embodiment, the ratio of tailings to water is greater than about 4.0 (v/v).

In one embodiment, the pore water released from the tailings into the water layer comprises a naphthenic acid concentration between about 50 mg/L to about 90 mg/L. In one embodiment, the pore water has a polycyclic aromatic hydrocarbon concentration less than about 1.0 μg/L about 3.0 μg/L. In one embodiment, the FFT has a bitumen content between about 1.5 wt % and 5.0 wt %.

In another aspect, a method of skimming floatable material from the surface of the water capping the tailings deposit is provided, using a modified barge positioned within the water layer and comprising:

i) a floating platform;

ii) a bottom plate;

iii) a pair of weir plates extending upwardingly from the bottom plate to define a pump chamber;

iv) a submersible pump extending from the platform downwardly into the chamber; and

v) screens separating the pump chamber from the weir plates, the screens and the weir plates defining a second chamber housing an air bubbler.

In yet another aspect, a method of skimming floatable material from the water layer capping the tailings deposit is provided, using a barge equipped with a submersible pump and an air bubbler positioned within the water layer capping the tailings deposit.

As used herein, the term “floatable material” is meant to refer to any material which accumulates on the water surface including, but not limited to, free phase bitumen which may be present as continuous or discontinuous mats, hydrocarbon sheens, oil films, fine mineral solids which do not readily settle, foams, emulsions, and debris such as plastic, wood, or the like. In one embodiment, the floatable material is bitumen which can be recovered from the water layer capping the tailings deposit and directed to a processing plant.

Additional aspects and advantages of the present invention will be apparent in view of the description, which follows. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will now be described by way of an exemplary embodiment with reference to the accompanying simplified, diagrammatic, not-to-scale drawings:

FIGS. 1A and 1B are general schematics of one embodiment of a reclamation method of the present invention using FFT, particularly MFT, and water capping. In particular, FIG. 1A illustrates the initial water cap depth, while FIG. 1B illustrates the anticipated consolidated depth after completion of tailings densification.

FIG. 2 is a graph showing the change in density of fine tails (expressed as fines content, calculated as f/(f+w), where f=fines<22 μm and w=water) with time in the presence and absence of methanogenesis. Densification of fine tails in experimental columns that contained methanogenic MFT (monitored for 343 days) is compared to non-methanogenic MFT sourced from MLSB and placed in the bottom of an experimental Demonstration Pond to assess the water capping concept.

FIG. 3 is a graph showing the prediction of MFT densification trajectories over time, based on monitoring data collected from active settling basins (MLSB and WIP), in areas of active methanogenesis (upper line, y=9.2 ln(x)+20) and areas with no measurable methanogenesis occurring (lower line, y=6.6 ln(x)+18). Change in density is expressed in relation to the fines content (calculated as f/(f+w), where f=fines<22 μm and w=water).

FIG. 4 shows results of groundwater monitoring well (piezometer) locations around WIP, used to assess potential seepage of OSPW. Diameter of the circles on the graph relates to the concentration of salts in the water samples. The much larger circles representing basal groundwater indicate that the natural groundwater is far more saline than WIP MFT pore water, WIP_SW_1996=surface water sample from West In-Pit collected in 1996; MFTPW=MFT pore water sample; BML1_2006=basal groundwater sample collected from well 1 in 2006.

FIG. 5A shows changes in salinity and concentrations of ionic species in test pond water caps over two decades of monitoring. A) conductivity; B) sodium; C) chloride, Pond 1=reclamation reference (no MFT, no OSPW); Pond 4, 6 & Demonstration Pond=MFT, natural surface water cap; Pond 5=MFT, OSPW water cap; Pond 9=no MFT, OSPW water only.

FIG. 5B shows changes in concentrations of ionic species in test pond water caps over two decades of monitoring. D) sulphate; E) alkalinity; F) calcium. Pond 1=reclamation reference (no MFT, no OSPW); Pond 4, 6 & Demonstration Pond=MFT, natural surface water cap; Pond 5=MFT, OSPW water cap; Pond 9=no MFT, OSPW water only.

FIG. 6 shows changes in concentrations of total naphthenic acids in test pond water caps over two decades of monitoring. A) Ponds not influenced by an initial OSPW cap (Pond 1=reclamation reference, no MFT, no OSPW; Pond 4, 6 & Demonstration Pond=MFT, natural surface water cap) B) Ponds influenced by an initial OSPW cap (Pond 5=MFT, OSPW water cap; Pond 9=no MFT, OSPW water only).

FIG. 7 shows degradation of naphthenic acids in constructed wetlands over a 36 week period. Left graphs indicate the pattern of chemical structures present in Syncrude OSPW at test initiation (T₀) and after 36 weeks retention time (T₃₆). Total concentrations were reduced from 70 to 13 mg/L over the 36 weeks. Right graphs similarly indicate the pattern in a commercial product at T₀ and after 16 weeks retention time (T₁₆). Total concentrations were reduced from 60 to 3 mg/L over the 16 weeks. n=carbon number, Z=hydrogen deficiency due to ring formation (Z=0, −2, −4, −6 . . . −12 indicate 0, 1, 2, 3 . . . 6 ring structures).

FIG. 8 shows the average PAH content (parent and degradation homologues) in MFT of WIP from samples collected at 10, 20 and 30 m depths in 2005-2007.

FIG. 9 shows seasonal and annual trends in dissolved oxygen measured in test ponds from 1989 to 1998 (near surface samples). Monitoring of oxygen continued beyond 1998, but in the summer months only. A—Ponds with OSPW in the water cap (Ponds 5, 9); B—Ponds with an initial natural surface water cap (Ponds 1, 2, 3, 4, 6); C—Demonstration Pond with a natural surface water cap and greater depth (2.5 m versus 0.5 m).

FIG. 10 shows the variation in dissolved oxygen with water depth in the cap layer of Demonstration Pond during summer months, 1994-2008.

FIG. 11 shows the maximum depth for macrophyte establishment in Alberta lakes, as a function of water depth and light penetration. The line curve was derived from a regression of data from 12 Alberta lakes, where (Water depth)0.5=0.69·log(Secchi depth)+1.76. The shaded box shows the range of secchi depths measured in Demonstration Pond over the summer months, up to the pond maximum water depth of 3.6 m.

FIG. 12 shows changes in turbidity (measured as total suspended solids, TSS) in the surface water caps of test ponds, 1989-2003. Measurements were taken 3-5 times each year at 2 or more depths. A—Ponds with OSPW in the water cap (Ponds 5, 9); B—Ponds with an initial natural surface water cap (Ponds 1, 2, 3, 4, 6); C-Demonstration Pond with a natural surface water cap.

FIG. 13 shows a cluster diagram of water-bodies from the oil sands region, describing the key factors influencing diversity and abundance in benthic invertebrate communities. This visual representation was derived using data from sites and statistical techniques that identify the habitat qualities that exert the greatest influence on the communities present. Demonstration Pond=DP; ponds=TP (1, 2, 5 or 9).

FIG. 14 shows a graphic assessment of the similarities in phytoplankton communities established in water from test ponds and other water-bodies on the Syncrude lease site. Systems adjacent to each other on the graph had similar communities. Sites far from Mildred Lake and extending out along the labelled vectors had communities strongly influenced by naphthenic acids and salts.

FIG. 15 show the percentage of variation in phytoplankton species distribution explained by the main environmental variables for 13 water bodies sampled June-August 2001. NA=total naphthenic acids concentration in the water. Covariation refers to the portion of variability explained by the interaction of salts with naphthenic acids on species distribution.

FIG. 16 is a schematic diagram of a prior art outflow system for a tailings pond.

FIG. 17 is a schematic diagram of one embodiment of the modified floating barge of the present invention.

FIG. 18 is a schematic diagram of one embodiment of an outflow system of the present invention.

### DETAILED DESCRIPTION OF PREFERRED EMBODIMENTS

The detailed description set forth below in connection with the appended drawings is intended as a description of various embodiments of the present invention and is not intended to represent the only embodiments contemplated by the inventors. The detailed description includes specific details for the purpose of providing a comprehensive understanding of the present invention. However, it will be apparent to those skilled in the art that the present invention may be practised without these specific details.

The present invention relates to a method of reclamation using tailings and water capping. As used herein, the term “tailings” means tailings from a mining operation and the like that contain a fines fraction. As used herein, “oil sands tailings” mean tailings derived from an oil sands extraction process and include fluid fine tailings (FFT) from tailings ponds and fine tailings from ongoing extraction operations (for example, flotation tailings, thickener underflow or froth treatment tailings) which may or may not bypass a tailings pond. In one embodiment, FFT useful in the present invention is centrifuged FFT, in-situ FFT (pond bottoms), dewatered rim ditch FFT, thickened FFT, or FFT that has not been dewatered.

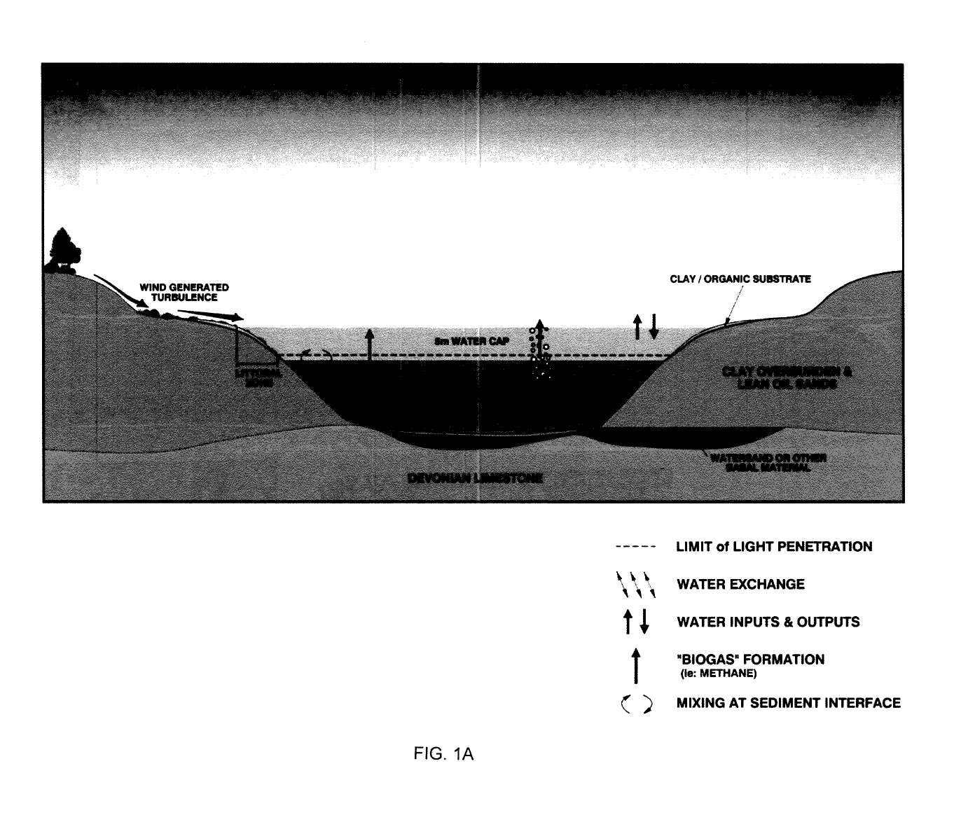

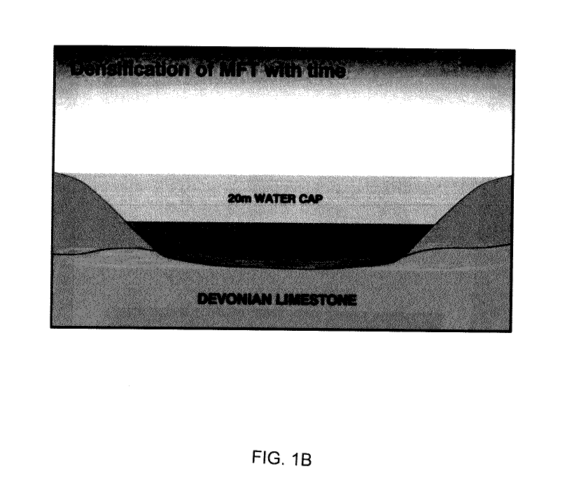

FIGS. 1A-B are general schematics of one embodiment of a reclamation method of the present invention using tailings, particularly FFT, and water capping. Untreated tailings are deposited “below grade” (i.e., below the original land surface) into a pit such as a mined-out pit. As used herein, the term “mined-out pit” refers to the excavated hole left after surface mining of oil sands has been completed. In one embodiment, the mined-out pit is lined by a clay substrate. As used herein, the term “clay” refers to a fine-grained textural class, made up largely of clay minerals, but commonly also having amorphous free oxides and primary minerals. With regard to particle-size, clay has a grain size less than about 0.002 mm equivalent diameter. The clay substrate acts as a barrier to impede ground water interactions. Below grade placement omits the long term requirement for dyke construction for containment. In one embodiment, the tailings has a solids content of at least about 30 wt %, with greater than about 60% of the solids comprising fines.

A layer of water of sufficient depth and volume is placed over the tailings. The water may be natural surface water (for example, muskeg drainage or surface runoff water) or oil sands process-affected water (“OSPW”). In one embodiment, the depth of the water layer is equal to or greater than about 5 meters. As used herein, the term “fetch” refers to the length of open water available for wind-induced waves. In one embodiment, the fetch is less about 4 km.

In one embodiment, the ratio of tailings to water is greater than about 4 (v/v). In one embodiment, the volume of the water layer ranges from about 35×10⁶ m³ to about 40×10⁶ m³. In one embodiment, the volume of the tailings is greater than about 175×10⁶ m³.

FIG. 1A illustrates the initial water cap depth, while FIG. 1B illustrates the anticipated consolidated depth after completion of tailings densification. As used here, the term “densification” refers to the natural consolidation of fine tails over time by the squeezing of water from pores in a saturated soil and a consequent decrease in the void ratio. Pore water contains dissolved organic and inorganic compounds that originate from the oil sands themselves (e.g., salts, naphthenic acids, hydrocarbons, trace metals), and material added during processing of the sands (e.g., caustic, diluents, naphtha, ammonia). However, the compounds may not pose a risk to the biological community in the lake ecosystem. In one embodiment, the pore water released from the tailings into the water layer contains napthenic acids at concentrations between about 50 mg/L and about 90 mg/L. In one embodiment, the pore water has total polycyclic aromatic hydrocarbon concentrations less than about 3.0 μg/L. In one embodiment, the FFT has a bitumen content between about 1.5 wt % to about 5.0 wt %. The tailings densify without mechanical or chemical intervention.

The water layer effectively caps the tailings to form a lake habitable for plants and animals. In addition to presenting a safe, low energy option for reclamation of tailings, the wet landscape setting for the tailings allows the construction of viable lake ecosystems in a reclaimed landscape.

As set out in the Examples, research and monitoring of experimental test ponds have been conducted to validate the invention as a suitable reclamation option. The test ponds were representative of chemical concentrations, degradation pathways and overall water quality; the general nature of fluxes across the water-fine tails interface; development timelines; biological colonization rates and community development in littoral zones; accumulation rates for detritus at the water-fine tails interface; changing toxicity profiles over time; and some water balance elements, such as the variability between estimated and actual precipitation and evaporation rates (Example 1).

The stability of the water capping layer and tailings was assessed in view that wind blowing across the water surface can produce orbital currents which may act alone or in combination with seasonal temperature stratification in the water column to exert force on the MFT interface (Example 2). Factors such as fetch, wind speed, water depth, sediment properties and the efficiency of the energy transfer to the water surface (landscape aspect, cover) influence the impact of wave action. However, the initial depth of the water cap is controllable. While the scale of the test ponds rendered them inadequate to investigate wave action, they provided information on the changing structural nature of the water cap-MFT interface over time, including the rate of build-up of detritus (decaying plant and animal materials). Research on interface stability focused on the physical properties of MFT, monitoring of the interface in active settling basins, and modeling of wave actions to address the issues of whether the placement of water over the tailings might be maintained without mixing; the energy in a water capped lake system required to disturb the water-fine tails interface, the frequency, and effects on the lake ecosystem; and lake basin design parameters which might minimize turbulence.

The properties and processes which change the water quality and result in biological development over time were assessed. Example 3 relates to groundwater interaction (i.e., to what extent, if any, would groundwater recharge or discharge affect the local and regional hydrological cycles; and would the clay of the basin prevent or slow the release of pore water from MFT), and the flux across water cap-fine tails interface (i.e., to what extent would upward flow of pore water and biogenic gases from the MFT zone into the water cap occur; how would that affect capping water quality in the short- and long-terms; and would releases introduce mineral solids or hydrocarbons into the water cap lake environment).

Example 4 addresses the toxicity of water capped tailings to aquatic life (what are the principle sources of toxicity in the substrate and water zones; how can they be characterized; and how do effects change over time); and ecological development (what are the rates and nature of biological colonization of water and sediment zones; and can ecosystem function eventually be described as healthy or viable).

Example 5 addresses littoral zone development (e.g., how can the sloping morphology of an end-pit be enhanced to favour shoreline development; and will there be sufficient littoral zone area relative to total lake area to support key life processes of a viable ecosystem).

It was found that the present invention involving water capping as a treatment and reclamation option for handling tailings may confer one or more of the benefits summarized below:
It does not require chemical or mechanical treatment of the tailings;
It allows design flexibility with to the type of pit used and physical aspects of construction;
It does not require large volumes of water from surface drainage, rivers or lakes surrounding the tailing pond if OSPW is used for the water capping of the tailings;
It appears robust to the normal operational variability expected in fine tails composition due to varying ore properties and processing conditions;
It requires minimal energy and associated greenhouse gas emissions to implement compared to other reclamation options;
It does not produce by-products requiring off-site disposal, other than the use of a water outlet to a natural water source;
It is an efficient method of storing tailings, allowing densification to occur passively without mechanical or chemical intervention;
It provides a large water reservoir with extended water retention times greater than about ten years, so that natural degradation processes for oil sands process-affected material may proceed;
It provides a point collection source landform release water and environmental surface water from adjacent reclaimed mine sites which may contain residual bitumen and naphthenic acids, salts, etc; and
A “pit lake” is in effect a water treatment process that remediates OSPW to a form where is can support freshwater aquatic life to allow the lake to be integrated into the watershed. In other words, it acts as a “water treatment plant” as well.

Conventional outflow systems to remove water from tailings ponds typically involve use of siphon systems or floating barges equipped with pumps to source water at depths of about two meters below the surface of the tailings pond (FIG. 16). However, such systems fail to remove stagnant water and floatable materials from the surface. As used herein, the term “floatable material” is meant to refer to any material which accumulates on the water surface including, but not limited to, free phase bitumen which may be present as continuous or discontinuous mats, hydrocarbon sheens, oil films, fine mineral solids which do not readily settle, foams, emulsions, and debris such as plastic, wood, or the like. These materials negatively impact water quality, waterfowl, wildlife, and aesthetics; increase emission of volatile organic compounds and turbidity; and reduce oxygen transfer, surface evaporation, and light penetration in littoral zones impacting lake ecology.

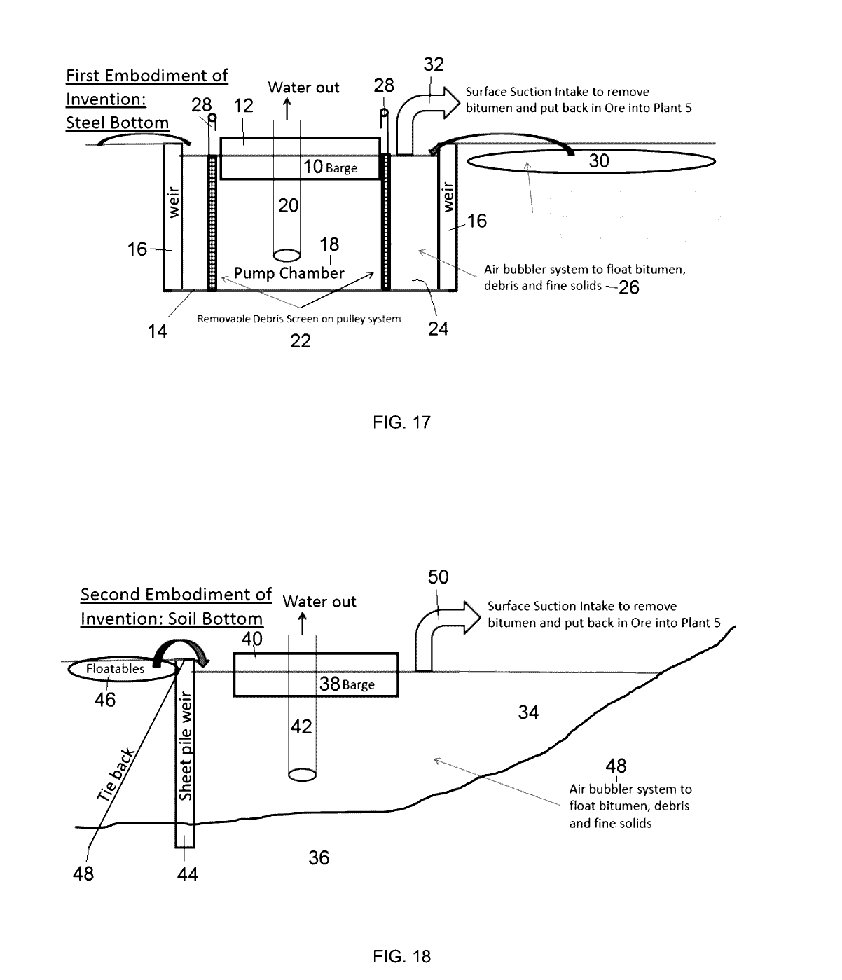

In another aspect, the invention is thus directed to a method of skimming floatable material from the water layer capping the tailings deposit. Turning to the specific embodiment shown in FIG. 17, tailings produced from bitumen extraction is deposited into a tailings pond. When the lake begins to form, active tailings depositions are terminated and replaced with fresh water input. A layer of water of sufficient depth and volume is placed over the tailings. The water may be natural surface water or OSPW. In FIG. 17, only the surface of the water layer is shown for clarity. FIG. 17 illustrates a conventional barge 10 that has been substantially modified to provide an overflow weir to permit collection and pumping of surface overflow water, and removal of floatable materials therefrom. Although barges can vary in dimensions, this invention is applicable to all sizes.

The barge 10 is positioned within the water layer. The barge 10 comprises a floating platform 12, a bottom plate 14, and a pair of weir plates 16. In one embodiment, one or more of the bottom plate 14 and the weir plates 16 are formed of steel. The weir plates 16 extend upwardingly from the bottom plate 14 to define a pump chamber 18. The barge 10 has a submersible pump 20 which extends from the platform 12 downwardly into the chamber 18.

Screens 22 separate the pump chamber 18 from the weir plates 16. The screens 22 and the weir plates 16 define a second chamber 24 which houses an air bubbler 26. In one embodiment, there is a pair of screens 22. In one embodiment, the screens 22 are removable by corresponding pulleys 28.

The weir plates 16 extend upwardly to a height above the screens 22 such that overflow surface water 30 carrying floatable material flows over the weir plate 16 into the second chamber 24. The air bubbler 26 generates a continuous flow of fine air bubbles into the surface water 30. The air bubbles attach to any floatable material (i.e., bitumen, debris, and fine solids) which floats and can be recovered. In one embodiment, a surface suction intake 32 removes bitumen and directs it to a processing plant (not shown).

The pump 20 pumps the surface water 30 through the screens 22 from the second chamber 24 into the pump chamber 18. As the surface water 30 is being pumped from the second chamber 24 into the pump chamber 18, the screens 22 capture any remaining debris in the surface water 30. The screens 22 may be removed upwardly for cleaning or replacement by the pulleys 28. The surface water 30 is pumped upwardly out of the pump chamber 18 and directed to a processing plant or holding tank (not shown).

Turning to the specific embodiment shown in FIG. 18, tailings stream(s) produced from bitumen extraction is transferred to a tailings pond that will become a pit lake. A layer of water 34 of sufficient depth and volume is placed over the tailings 36. The water may be natural surface water or OSPW. FIG. 18 illustrates a conventional barge 38 positioned within the water layer 34. The barge 38 comprises a floating platform 40 and a submersible pump 42 which extends from the platform 40 downwardly into the water layer 34.

A portion of the pit lake (e.g., bay area) proximate to the barge 38 is provided with a weir 44 to permit collection and pumping of surface overflow water 46, and removal of floatable material therefrom. In one embodiment, the weir 44 is formed of steel sheet pile which is placed into the tailings 36 and secured in position by a tie back 48, which itself is securely positioned within the tailings 36. The weir 44 extends upwardly from the tailings 36 to a height above the surface of the water layer 34. The overflow surface water 46 carrying floatable material flows over the weir 44.

An air bubbler 48 is positioned on the opposite side of the barge 38 to generate a continuous flow of fine air bubbles. The air bubbles attach to any floatable material (i.e., bitumen, debris, and fine solids) which floats and can be recovered. In one embodiment, a surface suction intake 50 removes bitumen and directs it to a processing plant (not shown). The surface water 46 is pumped upwardly by the pump 42 and directed to a processing plant or holding tank (not shown).

Using one of the embodiments shown in FIG. 17 or 18, the removal of floatable material from the water capping layer is desirable to expedite reclamation or the development of the pit lake and to improve the lake's aesthetic properties. In particular, removal of hydrocarbon sheens or oil films improves the overall rate of oxygen transfer into the water column. This helps to maximize concentrations of dissolved oxygen present in the water necessary to promote aerobic degradation of compounds (e.g., naphthenic acids) responsible for acute toxicity and enable development of aquatic life necessary for lake development. The presence of hydrocarbon films reduces the rate of oxygen transfer into the water.

### Example 1

### Field Test Ponds

Tests were conducted using surrogate lake basins or test ponds ranging from 2,000 m³ to 140,000 m³ total volume (MFT+water) and excavated in Pleistocene clay. Ponds 1-7 were built in 1989, while Ponds 8-10 and Demonstration Pond (Pond 11) were built in 1993. The changes in the physical and chemical properties within the test ponds were monitored as they aged. The MFT deposited in the test ponds originated from the Mildred Lake Settling Basin (MLSB), and had been densifying for about eight years. The MFT had a solids content of 30 wt %, with over 95% being fine silts and clays. The water for capping was natural surface water (muskeg drainage and surface runoff waters drawn from the West Interceptor Ditch) or oil sands process-affected water (OSPW) transferred from the free water zone of MLSB. The following test ponds enabled comparison of the developing systems and attribution of the resulting physical, chemical and biological conditions to MFT-, OSPW- or sodic (sodium-rich) clay overburden-dominated influences:
No MFT in an in-place clay substrate basin filled with natural (non-OSPW) surface water (Pond 1; a reclamation reference system).
No MFT in a clay substrate basin filled with OSPW water (Pond 9).
MFT capped with OSPW water in a clay substrate basin (Ponds 5, 8 and 10).
MFT capped with natural surface water in a clay substrate basin (Ponds 2, 3 and Demonstration Pond).
MFT capped with natural surface water and inoculated with plants and invertebrates (Pond 4).
MFT capped with natural surface water and fertilized with nitrogen and phosphorus (Pond 6).
MFT with no cap water incrementally filled from MFT pore water release (Pond 7).

Table 1 compares structural characteristics of the test ponds with projections for a large scale project referred to herein as Base Mine Lake.

TABLE 1
A comparison of the physical design and materials composition
of the water capping test ponds and Base Mine Lake

| Variable | Test Ponds | Base Mine Lake |
|---|---|---|
| Surface area (ha) | 0.05-4 | ~800 |
| Initial depth of water cap | 0.5-2.8 | ≧5 |
| (m) | | |
| Volume of water cap | (1-80) ^{×} 103 | (35-40) ^{×} 106 |
| (m3) | | |
| Volume of MFT (m3) | (1-80) ^{×} 103 | >175 ^{×} 106 |
| Volume ratio (MFT: | ~1 | >4 |
| water) | | |
| Maximum fetch (km) | 0.04-0.25 | >3 |
| Fill time (y) | <0.1 (all) | 17 (MFT) // 1-5 (water) |
| Hydrology | Closed (no surface | Open (flow-through) |
| | flow-through) | potential |
| Residence time (y) | >15 | >10 |
| MFT source a | MLSB North | MLSB South |
| Water cap source | natural surface | To be decided |
| | water or OSPW | |

### Example 2

### Stability of the Mature Fine Tails—Water Cap Layers

Samples of MFT for rheological studies were collected in 1989 from three sampling stations in the south, central and north zones of MLSB (every 1 m from 9 to 30 m) and again in 2006 from MLSB (30 sites) and West In-pit (WIP, 13 sites). The 1989 samples were on average about 30 wt % solids, had a gel-like character at low shear forces, exhibited a shear yield strength of about 40 Pa and viscosity of about 15 mPa·s (at 2770·s⁻¹), This MFT also showed very low permeability to flowing fluids like water (<10⁻¹⁰ m·s⁻¹). During the 2006 study, researchers confirmed previous findings, and detected an increase in density, shear yield stress and viscosity since 1989. The MFT sampled in the WIP in 2006 generally had a high fines content (>40 wt % fines <22 μm), was bitumen-enriched (5-15 wt %) and densified through the release of pore water; these characteristics were associated with increased MFT strength. The 2006 study also found considerable variability in the composition of MFT among the hundreds of samples collected from MLSB and WIP.

To examine the impact of wind-generated orbital wave energy on disturbance of MFT, a laboratory simulation of wave action was undertaken. Threshold velocities needed to disturb samples of immature (<35% solids content) and mature (>35% solids content) fine tails collected from MLSB were measured using a wave and current flume. The flume tests indicated the critical threshold velocity for disturbance of MFT (35% solids by weight) as 0.04 m·s⁻¹. Wave-induced turbulence at that critical velocity would result in a small amount of re-suspension, approximately 1 kg·hr⁻¹·m⁻².

Rapid settlement of fines suspensions in the free water zone of an active settling basin was documented while monitoring suspended particles and wind action in MLSB during the late summer and early fall of 1991. The information collected in MLSB on suspended solids and wind speeds during September, October and November 1991 suggest that re-suspension may occur under conditions present in the fall in an active settling basin, with re-settlement complete within 24 hours of wind cessation. Since fines at the free water interface in an active settling basin had not densified to 30 wt %, the data on the magnitude and duration of potential episodic re-suspension events in a water capped system require the repetition of such studies in a full-scale lake.

The energy needed for MFT disturbance measured during the hydraulic flume testing was applied to a linear wave theory model, along with data on historical wind velocities for the Fort McMurray area, a theoretical lake fetch of 3-5 km and a statistical factor describing potential wave heights. From these inputs, the model predicted that a water cap depth of 5 m or more would be needed to prevent MFT re-suspension during a 100-year storm event (18.5 m·s⁻¹ wind speeds).

The probability of seasonal water turnover in the capping layer is high for Base Mine Lake. According to models, an exchange of bottom and surface waters (turnover) may occur once each year in the early fall. A salinity-driven density gradient is predicted to exist from ice-off in the spring through to fall, thereby preventing a spring turnover event. Fall turnover is driven by wind mixing once the combined salinity and temperature stratification dissipates within the water column at the close of summer. The mixing process leads to a form of orbital water movement which has the potential to re-suspend some solids at the interface if they have little or no cohesive strength. However, fall turnover events are also an important component of boreal lake energy cycling, because they serve to replenish oxygen in the water before the ice-covered winter season begins. Spring turnovers are not as common in northern deep lakes and end-pit lakes, because surface waters tend to warm up and thermally stratify quickly.

Continuing densification of MFT under a lake water cap will reduce the likelihood of MFT suspension with wind action or fall turnover as time goes on. The original estimate of a slow densification rate has been amended since 1996. At that time, areas of vigorous methanogenic activity, associated with accelerated densification and increased MFT strength, began to appear in MLSB. As sulphate levels decrease, methanogens become more active and the result is clearly visible in MLSB and WIP as gas bubbles at the pond surface. The escape of this gas from the MFT, through the water cap and into the air may create drainage paths within the MFT as it facilitates consolidation. Also, the carbon dioxide respiration product will change the pore water chemistry. The physical effect is an increase in the densification rate of the MFT zone.

In mesocosm experiments conducted with methanogenic MFT over 343 days, rapid densification from 30-38 wt % solids content occurred. In comparison to non-methanogenic samples, this corresponded to a density increase expected (from empirical models) over a 16 year period. Subsequent rheological analyses verify that this accelerated densification produces a significant increase in shear yield stress and viscosity of MFT. The result of this action would be a substantial increase in the stability of the MFT zone.

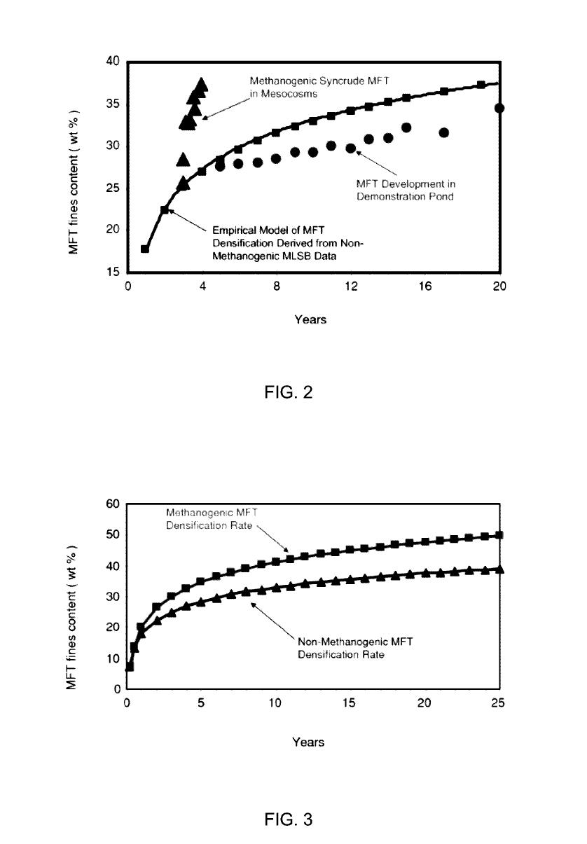

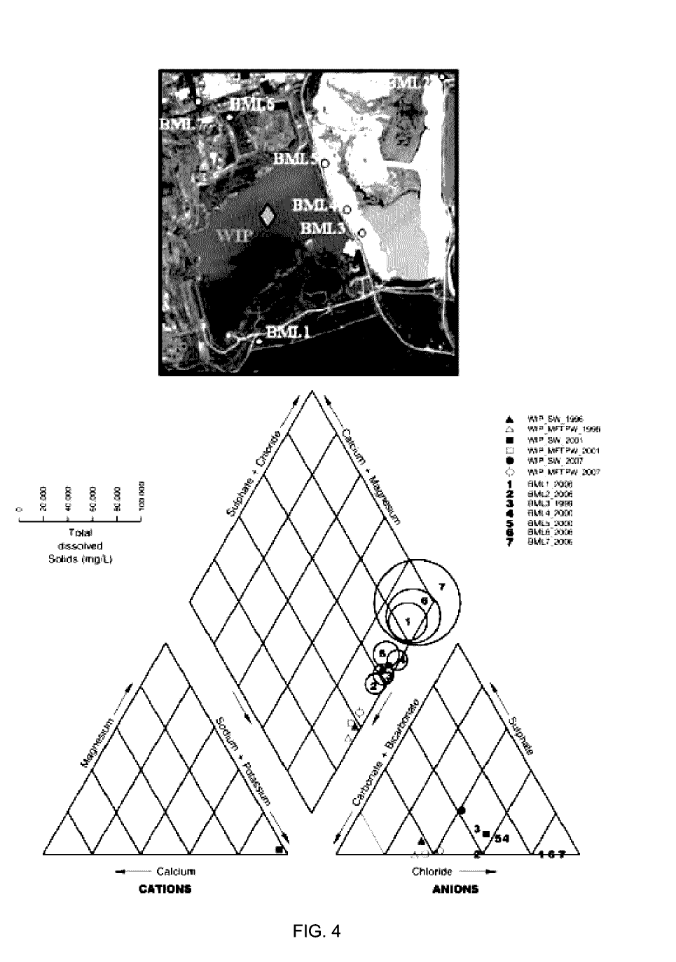

The proportion of methanogens in the microbial community can be highly variable, even within the MLSB. Ongoing monitoring of the test pond MFT zones has indicated that they are following the densification trajectory of non-methanogenic MFT (FIG. 2). For instance, the MFT used to construct Demonstration Pond was drawn from the northern end of MLSB in 1993, where no evidence of methanogenic activity was seen at the time. The MFT zone in Demonstration Pond has exhibited a low level of methanogenesis and a slow rate of densification. Monitoring of methanogenic activity and densification rates in MLSB and WIP (where MFT was transferred from MLSB beginning in 1995) has provided data for calculation of an altered, accelerated trajectory in methanogenic systems (FIG. 3).

The susceptibility of the water cap-MFT interface to disturbance may also be influenced over time by the accumulation of detritus on the interface surface. The condition of this surface zone has been monitored by core sampling, remote-sensing equipment, and survey videos taken in 1997 and 2008 which show a detritus layer accumulating at the MFT interface, Biological activity was evident. An organic layer 1-2 cm thick and a zone of microbial activity 3-7 cm thick were discernible in core samples taken in 2008. Bioturbation of the water cap-MFT interface by benthic invertebrates may disturb the layering in the shallow test ponds. In a full-scale lake, the extent of bioturbation and its effect on mixing of detritus overlying MFT may depend upon the macroinvertebrate community density, species composition, and increasing depth of the detritus layer over time.

The above results suggest that the interface will be resistant to any sustained mixing under the depth and fetch conditions expected in Base Mine Lake, given a similar MFT solids/fines content as that used for testing (>30 wt % solids content with greater than 60% of solids as fines).

### Example 3

### Groundwater Interactions

Interstitial pore water held in MFT contains concentrations of dissolved organics and inorganics. Seepage of this pore water into groundwater and subsequently into local surface waters of the Athabasca River watershed was of concern. However, the MFT had a very low hydraulic conductivity, meaning that water movements through the MFT were slow (<10-10 m·s⁻¹) and potential recharge into a surrounding aquifer would be negligible. The geology of the Base Mine Lake containment basin is largely limestone (bottom) and clay (sides), which also exhibit low hydraulic conductivity.

Monitoring for potential deep groundwater interactions with Base Mine Lake began in 1998, using data collected from nine groundwater wells (called piezometers) located around the perimeter of the existing basin. The water recharge in several of these wells was too slow to permit sampling; this is consistent with the low hydraulic conductivity of clays and limestone and slow overall flow. Of those wells which could be successfully purged and analyzed, two located east of WIP have shown changes in hydraulic head that may be the result of water movement from MFT in WIP. Movement of this water eastward would place it in the vicinity of East In-Pit (EIP). Monitoring of four other wells located to the north and south of WIP indicates no movement in those directions from WIP.

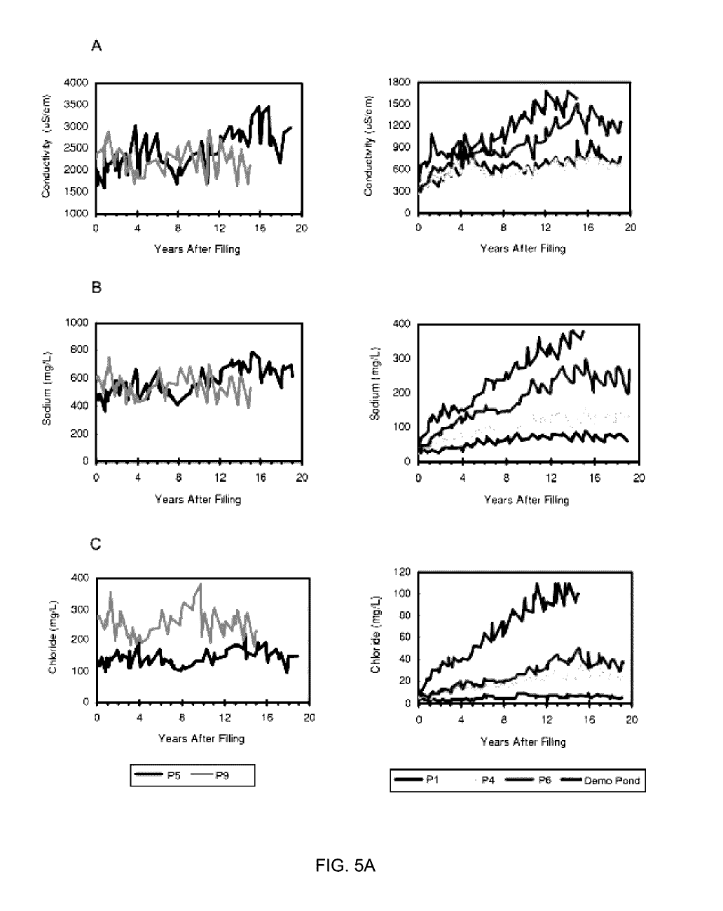

Chemical analysis of water in all wells indicate that the deep basal groundwater surrounding the basin is naturally saline (10,000-70,000 mg/L total dissolved solids). Positioning of the site labels in FIG. 4 indicate how similar or dissimilar the ionic makeup is among the basal groundwater and WIP pore water samples: the closer the clustering of sites on the triangles and diamonds, the more similar is the character of their salinities. The diameter of the circles in the upper diamond relate to the total concentration of salts, and indicate that the basal groundwater is several fold more concentrated in salts than the WIP pore water. Measured naphthenic acids concentrations are elevated in pore water compared to the groundwater (60-90 mg/L in pore water, 5-35 mg/L in basal groundwater).

Table 2 summarizes MFT pore water properties in the WIP. The compounds are considered the more likely source for the stress responses observed in aquatic life. The concentrations represent MFT samples collected as the WIP has been filling since 1995. During that time, there were some marked changes in the chemical nature of the pore water samples, in part the result of process changes, composition of oil sands ores and microbial degradation. Concentrations of sodium, chloride, and bicarbonate increased in pore water in later sample years. Sulphate concentrations decreased with depth and age of MFT. Changes made to the upgrading process at the end of 2006 resulted in higher concentrations of ammonia in tailings water; increased ammonia in pore water was subsequently reported in 2007. These units have since been optimized and ammonia concentrations in tailings water have returned to historical levels.

TABLE 2
Chemicals in MFT pore water and surface water of Demonstration
Pond and the WIP settling basinₐ

| | Demonstration Pond | | WIP |
|---|---|---|---|
| | (1993-2006) | | (1995-2007) |
| | | MFT pore | MFT pore |
| Constituent | Water cap | water | water |
| pH | 7.4-9.5 | 7.8-8.8 | 7.2-8.6 |
| Major Ions (mg · L−1) | | | |
| Sodium | 50-380 | 430-590 | 600-1000 |
| Potassium | 1-8 | 7-22 | 10-20 |
| Magnesium | 13-22 | 2-7 | 5-25 |
| Calcium | 10-70 | 3-10 | 5-30 |
| Chloride | 10-110 | 125-200 | 350-650 |
| Sulphate | 60-190 | 1-190 | <25 |
| Blcarbonate + | 190-596 | 700-1050 | 960-1710 |
| Carbonate | | | |
| Conductivity (μS · cm−1) | 425-1680 | 1685-2210 | 2000-4000 |
| Naphthenic Acids | 4-16 | 45-90 | 50-90 |
| (mg · L−1) | | | |
| Polycyclic Aromatic | <1 | <2.5 | <1-3 |
| Hydrocarbons (μg · L−1) | | | |
| Bitumen (wt % of | — | 0.8-1.1 | 1.5-5.0 |
| MFT) | | | |
| Total PAHs In MFT | — | 100-200 | 100-250 |
| (μg · g−1) | | | |
| Metals & Metalloids | | | |
| (mg · L−1) | | | |
| Lead | 0.001-0.03 | 0.001-0.03 | 0.003-0.017 |
| Mercury | <0.0005 | <0.0005 | <0.0005 |
| Aluminum | 0.09-2.5 | 1.88 | 0.4-5.7 |
| Arsenic | <0.0015 | <0.2 | 0.01-0.10 |
| Boron | 0.4-0.7 | 2.7-3.7 | 2.5-3.5 |
| Cadmium | <0.01 | <0.003 | <0.003 |
| Iron | 0.08-0.75 | 0.45 | <0.05-1.2 |
| Lithium | 0.022-0.034 | 0.112 | 0.2 |
| Selenium | 0.01-0.03 | 0.026 | |
| Strontium | 0.28-0.29 | 0.21 | 0.4-0.7 |
| Ammonium (as NH4+) | 0.01-1 | 2-8 | 7-20 |
| (mg · L−1) | | | |

ₐDemonstration Pond water cap samples from 0-2.5 m depth, MFT pore water from MLSB in 1993; WIP average solids content of samples = >25 wt %

i) Salts

As shown in Table 2, natural minerals are present in pore water as unbound ions; those contributing to overall salinity include sodium, chloride, sulphate, calcium, potassium and magnesium. Elevated salt levels are common in the soils of the oil sands region. They originate from the clay and shale deposited during the Cretaceous period when Alberta was an inland sea. When in contact with water, salts readily dissolve. They concentrate in OSPW because of mine water recycle practices. The degree to which salts are added to a water capped system will vary with the water cap source, MFT pore water release rates, the depositional history of the in-place and reclaimed soils present in the watershed and their hydraulic conductivity. In MFT release water (pore water released to the water cap) the dominant ions are sodium, chloride and bicarbonate (Table 2).

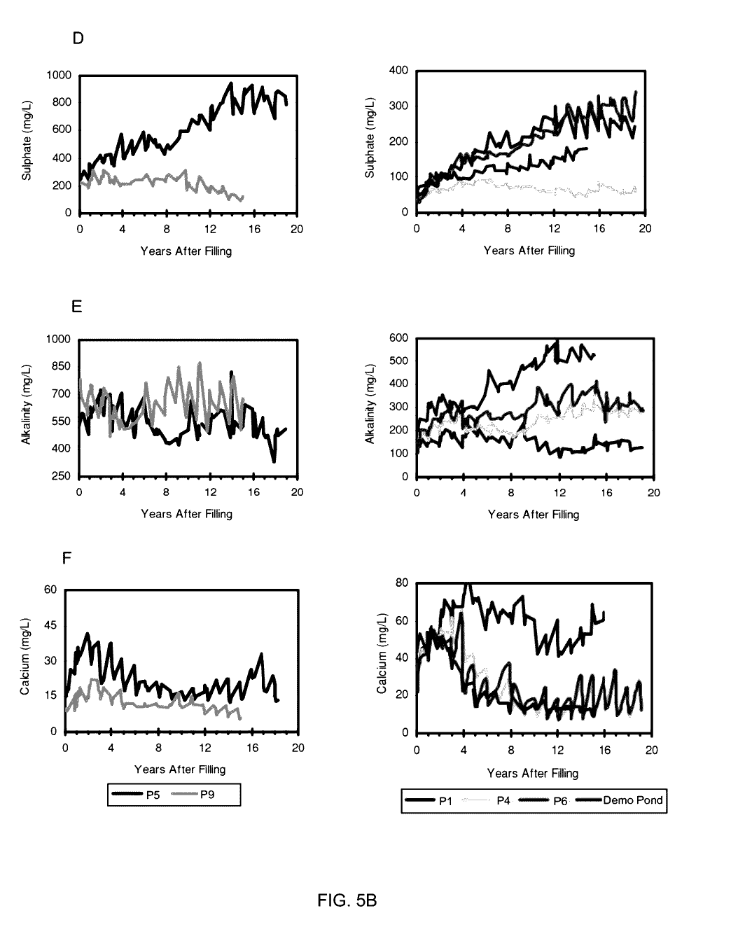

The comparative influence of overburden clays, MFT and OSPW on ionic content of the water cap has been evaluated over time in test ponds through an annual chemistry monitoring program (FIGS. 5A-B). Sodium, chloride, ammonium, and naphthenic acids are good tracers of MFT release water loading to the water cap. Sulphate, which is effectively absent from MFT pore water (as a result of microbial reduction), is a good indicator of ion release into the water cap from basin clays as well as from bio- and geo-chemical processes that occur in oxygenated waters.

When the water quality in the water cap layers of the test ponds is examined, it is clear that ions are added as a result of MFT densification, OSPW introduction and clay basin re-working. Where the pond basin was excavated in overburden clays and filled only with natural surface water (the reclamation reference, Pond 1 in FIGS. 5A-B), sodium and calcium increased for the first 5-10 years before reaching a reasonably stable plateau. Sulphate also increased but chloride remained at low levels throughout the monitoring period. Chloride would be associated with release water (which was not present here), while the others are leaching from the clay basin.

Where MFT was introduced to the basin and capped with natural surface water (Ponds 4, 6 and Demo Pond in FIGS. 5A-B), chloride and sodium increased over time. The sulphate content also increased and this is not derived from the MFT pore water release. Microbial surveys have found phototrophic purple sulphur bacteria living in the detritus zone above the MFT interface and producing sulphate from sulphides (present as by-products of anaerobic photosynthesis). These microbes contribute to sulphate content in test ponds, because the ponds are shallow and light penetrates to the depth of the interface.

Where OSPW was introduced with (Pond 5) and without (Pond 9) an MFT layer the direct impact of MFT release water was masked by starting water cap properties (FIGS. 5A-B). Sodium and chloride concentrations showed minor changes over 10 years, except for a small increase in sodium in Pond 5. Statistical analysis detected a very small rate of decline in sodium in Pond 9. The only ion showing large changes was sulphate in Pond 5, which increased greatly. This and the smaller increase in the sodium content were likely due to the clay properties of the Pond 5 basin. The basin of Pond 9 seems to have had little impact on sodium in the water. In these two ponds, concentrations of most tracer ions were initially high, well above those in test ponds with a natural surface water cap. Trend analysis found that their rate of increase was not significantly different than other ponds, suggesting that the OSPW influence on higher ionic content would persist over time in closed systems.

The above results indicate that dissolved salts are added to the water cap from release water and clay basin leaching, and increase the salinity of the cap waters, particularly in closed systems (no surface water inputs or outputs) (FIGS. 5A-B). Sulphate will degrade, through the activities of sulphate-reducing bacteria in the upper MFT and detritus zones. However, other salts like chloride and sodium are not removed via biodegradation mechanisms. Salts leaching from terrestrial landscapes will come mainly from the sodic (sodium-rich) or sulphide-rich overburden clays present in some watersheds. After 15 years, ionic loading from the test pond clay basins still occurs.

When the water cap is initially natural surface water, the release of pore water from the MFT will affect the composition of the capping layer over the entire period of MFT densification. In the initial years, the rates of MFT dewatering are fastest (pore water release from MFT decreases as density increases). This means that, in initial periods of development, ion loading to a natural surface water cap will create water similar in composition to OSPW, but varying in absolute ion concentrations. Trend analysis suggests that closed ponds capped with OSPW will continue to exhibit higher dissolved concentrations of salts than ponds capped with natural surface water. Modeling of open systems with continuous flow-through indicates that the water residence time, rather than the initial water cap origin, is a determinant of surface water salinity levels.

ii) Naphthenic Acids

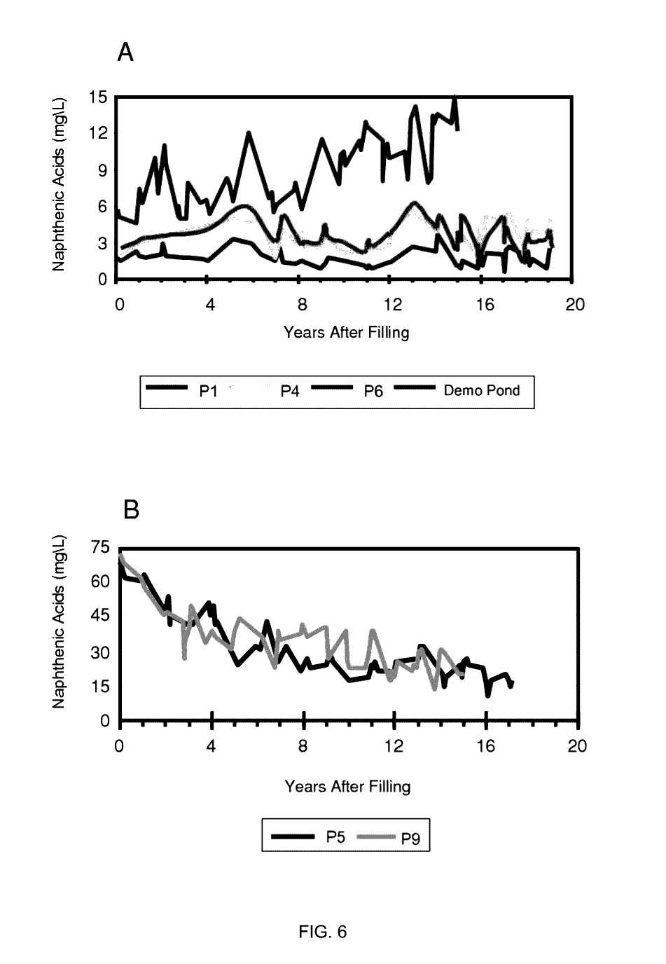

The caustic extraction process used to separate bitumen from the oil sand enhances the release of naphthenic acids from the bitumen into the process water, producing elevated concentrations in OSPW and in the pore waters of fine tails. Where neither MFT nor OSPW are present (Pond 1 in FIG. 6), naphthenic acids released from surrounding reclaimed soils and delivered through surface runoff to the pond water remained at a relatively constant background level of less than 4 mg/L.

In test ponds with a MFT bottom and initial natural surface water cap (Ponds 4, 6 and Demonstration Pond in FIG. 6), naphthenic acids were initially higher than in the reference pond, with concentrations ranging from 1-15 mg/L. Biodegradation was anticipated in the aerobic environment of the water cap layer, but laboratory studies indicate the presence of both labile (more easily biodegradable) and refractory (more difficult to biodegrade) fractions. Time trend analysis indicates that concentrations in Demonstration Pond are increasing over time, whereas concentrations in ponds 2, 3, 4 and 6 are not different from background and show no trend, either increasing or decreasing, over time. This suggests the rate of addition (from release water) is approximately equal to the rate of removal (via degradation) in all but one of five replicate ponds. Demonstration Pond differs in size (it is larger) and age (4 years younger) from ponds 1-7, which may contribute to this discrepancy. The correspondence of peaks and troughs among the test pond values suggest season may influence naphthenic acid concentrations. Statistical analysis confirms this, showing that values tend to be lower in the winter and more variable in the summer.

When OSPW was used for capping (Ponds 5 and 9) the initially high naphthenic acids content (>65 mg/L) showed a steady decline (about 50%) over the first five years, followed by a slower rate in the ensuing years to about 25-30% of the initial levels. This is consistent with the current understanding that the labile fraction degraded in the first period, while even after almost 20 years, the refractory fraction remains essentially un-degraded. Non-linear statistical trend analysis indicates that, in the most recent years of monitoring, naphthenic acids concentrations remained static in Ponds 9 and 10 (10-15 years post-construction), whereas they continued to decline significantly in Pond 5 (15-20 years post-construction). In 2008, naphthenic acids in ponds with MFT and OSPW (Ponds 5 and 10) remain significantly higher than in ponds with MFT and an initial natural surface water cap.

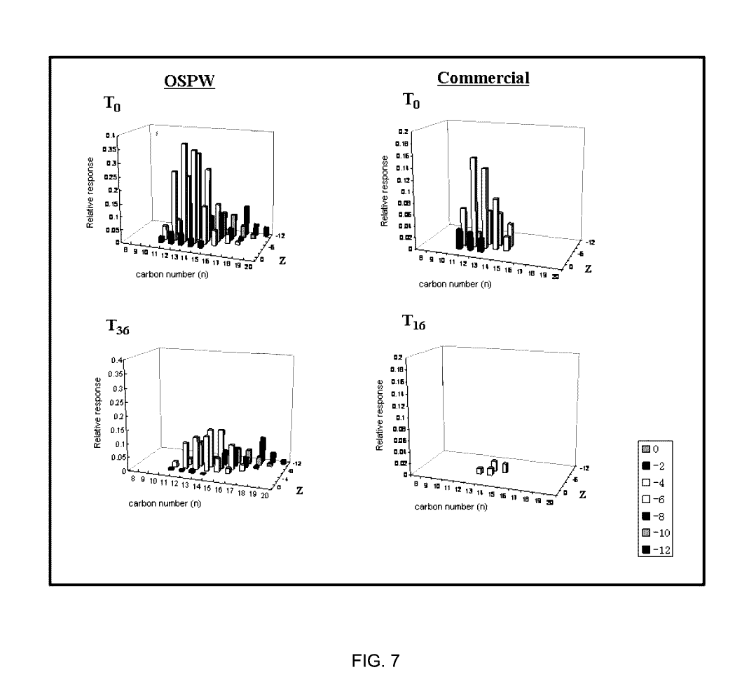

Laboratory studies suggested that those naphthenic acids having lower molecular mass, less than 21 carbons and fewer alkyl-substitutions in their structure were most readily biodegraded in OSPW. However, test data from more refined analytical techniques suggest that all naphthenic acids are degraded irrespective of molecular mass or ring structure. The retention of higher carbon number compounds was simply an indication that the parent compounds were being replaced by degradation products of similarly complex structure (FIG. 7). Biodegradation of naphthenic acids may be traced to the activities of Pseudomonas stutzeri and Alcaligenes denitrificans in water, and Pseudomonas putida and P. fluorescens in wetland sediments.

iii) Microbial Degradation of Pore Water Constituents

The studies of naphthenic acids in OSPW indicate that their partial degradation occurs in the aerobic (oxygenated) environments of the test ponds. Degradation of naphthenic acids under anaerobic conditions as expected in MFT was slow. Anaerobic degradation of other chemical constituents in MFT has important ramifications not only for densification rates but also for the overall chemical composition of release water. MFT contains three main groups of microbes engaged in anaerobic biodegradation: denitrifying bacteria, sulphate-reducing bacteria and methanogens. Nitrate and ferric iron may be used for respiration by denitrifying bacteria, which then produce ammonium, nitrite, nitrous oxide and/or nitrogen. This is a fairly rapid process and occurs near the surface of the MFT and at the water cap-MFT interface. Below these zones, sulphate, n-alkanes and naphthalene may be used by sulphate-reducing bacteria which convert them to sulphides, carbon dioxide and bicarbonate. Methanogens may use acetate, hydrogen and the n-alkanes in naphtha, and in turn they produce methane and carbon dioxide.

Denitrifying and sulphate-reducing bacteria out-compete methanogens in MFT, because they obtain more per unit energy from available substrates. In freshly-deposited MFT, the dominant substrate is sulphate, and the actions of the sulphate-reducing bacteria quickly deplete it. Even at elevated sulphate levels (>1000 mg/L), the consortium of anaerobes in the MFT have been shown to deplete sulphate by more than 90% in a matter of months. When sulphate levels are elevated, methanogen populations remain low.

The level of methanogenesis documented in MFT from settling basins and test ponds is variable. The rate in Demonstration Pond is much lower than in MLSB or in WIP. The community of microbes present and their rates of activity are dependent on physical states, pH, temperature, and chemical substrates (hydrogen, acetate, sulphate, nitrate, naphtha, bicarbonates, light hydrocarbons, aromatic compounds). The source of MFT for Demonstration Pond was a part of the MLSB that was not methanogenic. It did not contain the naphtha-rich tailings seen in the southern part of the MLSB where vigorous methane production was evident in the post 1993 period. Most of the MFT in the WIP has been transferred from the southern zone of the MLSB which is the most active methanogenic area. Light-end hydrocarbons are an important substrate for anaerobic microbes, and the microbial community in Demonstration Pond has been deprived.

iv) Ammonia

An increasing concentration of ammonium (NH⁴⁺) in OSPW has occurred since 2006 and is associated with the start-up of upgrading process units at the mine. As a result, the loading of ammonium to the process waters increased between 2006 and 2009. Process optimization has since reduced ammonia loading back to historical levels. In the anaerobic environment of the MFT, little change in the concentrations of NH⁴⁺ has been observed.

In its ionic form, NH⁴⁺ is transported from MFT with the release water into a water cap layer. At the interface, denitrifying bacteria converts ammonium to other forms (eg., nitrite, nitrate) and contributes to biochemical oxygen demand in the process. The relationship between ammonia and chemical oxygen demand (COD) was statistically significant in test ponds having an OSPW water cap. As ammonia increased, COD also increased, particularly under the ice in December and January.

Since ammonia volatilizes rapidly when exposed to air, its impact in a water-capped lake will be determined by the makeup of the microbial community (and rates of degradation) in combination with duration and depths of winter ice cover (which limit oxygen replenishment of water from air). Since test ponds varied markedly in these two variables from full-scale water-capped lakes, they were not well suited to evaluations of ammonia.

v) Polycyclic Aromatic Hydrocarbons (PAHs)

After the first few years, PAH levels in the test pond waters were not routinely monitored. The early analytical results showed both parent and alkylated PAHs at or below detection levels (<0.2 μg/L) in the water caps. In a study of the equilibrium levels of PAHs in the pore waters of MFT, the concentrations were at or below detection levels (<0.1 μg/L). High molecular weight PAHs with mutagenic potential were not found in MFT pore water. Low levels of lower molecular weight PAHs were detected in tailings water, but were removed quickly through combined processes of photo-oxidation, volatilization and biodegradation.

Two main groups of PAHs, namely phenanthrenes and dibenzothiophenes, were detected in sediments, MFT and/or suspended particulates from water caps of test ponds but not in the water phase. The origin of and sink for these constituents is most likely unrecovered bitumen in MFT and lean oil sands in excavated basins. As shown in Table 2, MFT pore water from WIP contains slightly higher concentrations of PAHs than that from Demonstration Pond, and that concentration difference is associated with a higher bitumen content in WIP MFT.

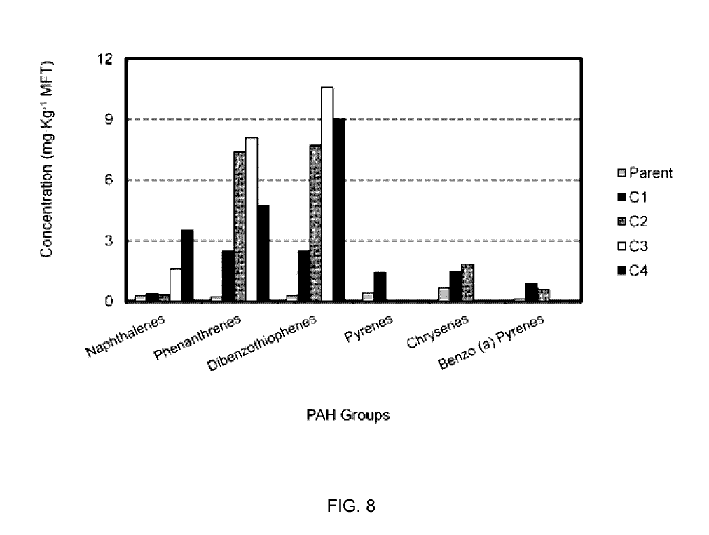

The limited sampling for PAHs in sediments of Demonstration Pond (1998-1999) indicate that it contains lower total concentrations than other reclaimed wetlands and two natural lakes influenced by surface runoff from reclaimed land (Crane and Horseshoe Lakes). In addition, the PAH congeners that are present are dominated by the C1 to C4 alkylated PAHs (FIG. 8), which are less soluble than parent compounds. This may explain the lower bioaccumulation factors in aquatic insects compared to those for natural systems. Bioaccumulation factors are an estimate of the uptake and retention of a chemical into living tissues (in this case, insects). Since sediment and insect sampling occurred only in Demonstration Pond and not the other test ponds, it remains unclear whether the reduced bioavailability is a phenomenon unique to Demonstration Pond or representative of MFT water capped systems in general.

A key difference between naphthenic acids and PAHs to consider when developing aquatic management strategies is that the mining process tends to increase concentrations of the former, while decreasing concentrations of the latter. PAHs are removed with the extracted bitumen; therefore, it is not unexpected that their presence in waters influenced by overburden containing lean oil sands is greater than in OSPW- or MFT-influenced systems. Although PAHs have the potential to create chronic toxicity in water-capped systems, these may be muted in comparison to their influence in other forms of reclaimed aquatic environments. There is evidence from natural environments that rates of biodegradation of PAHs are sensitive to dissolved oxygen levels, and thus oxygen fluctuations in water-capped systems due to season and MFT-related chemical and biochemical oxygen demands may influence the rate of decrease in PAHs over time.

vi) Dissolved Oxygen

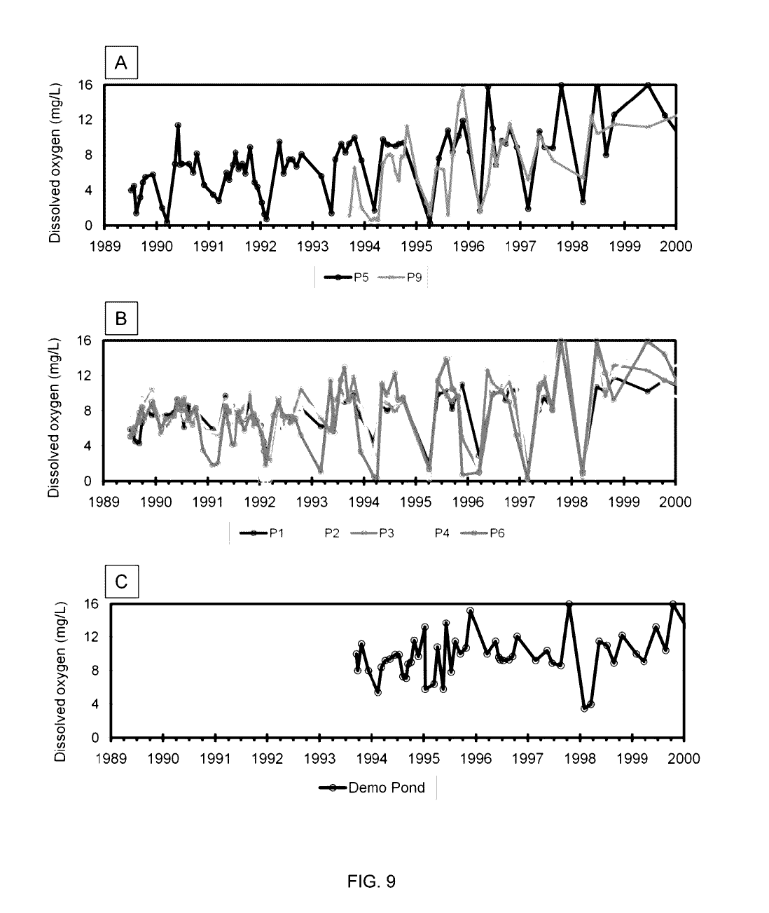

The oxygen levels in water caps have a key influence on rates of degradation for the organic constituents in release water, such as naphthenic acids and PAHs. Well oxygenated water is also critical for the maintenance of most aquatic life. Dissolved oxygen concentrations were monitored routinely in the test ponds (FIG. 9); the findings are consistent with what is known of regional natural systems where levels undergo extreme seasonal fluctuations. The presence or absence of OSPW in the initial water caps was not a significant influence on the seasonal oxygen profile in the cap. During the summer months, water was effectively saturated with oxygen, whereas in the winter in many years water went anoxic (that is, devoid of oxygen). The deeper Demonstration Pond was less vulnerable to winter anoxia than Ponds 1-7, with average winter dissolved oxygen remaining above 5 mg/L (FIG. 9).

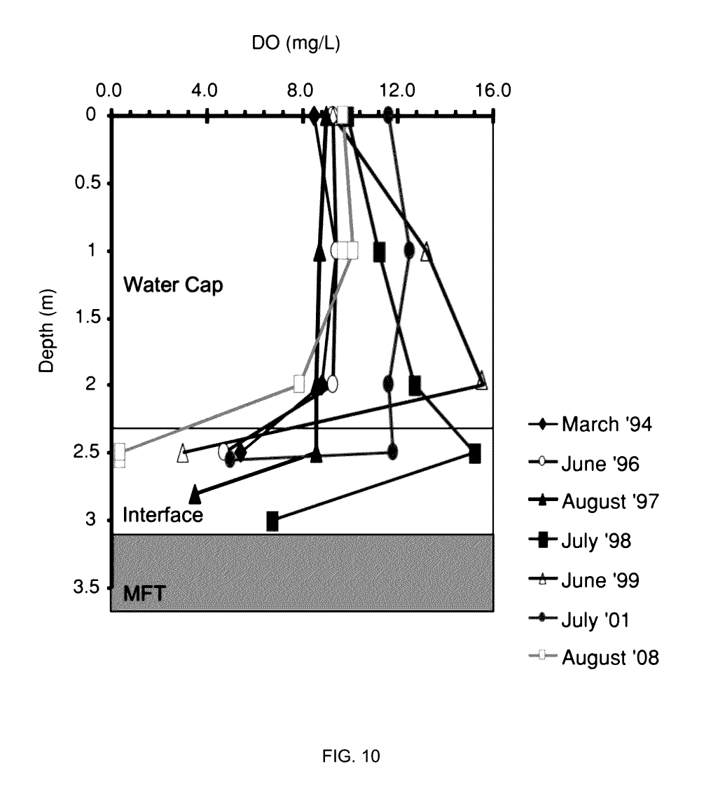

In all test ponds, a thin layer of depleted oxygen occurred throughout the year just above the interface with the MFT (FIG. 10). This zone in Demonstration Pond occurred within 20-40 cm from the MFT interface and approached anoxia even during some summer months. The lower oxygen at depth is likely indicative of the oxygen demand exerted by chemical degradation mechanisms generated by bacteria inhabiting this transition zone between sediment and water. Ponds with an OSPW cap tended to have greater COD than ponds with an initially natural surface water cap. In real time, dissolved oxygen concentrations fluctuate over the course of the day as well as throughout the year and with depth; thus, the monitoring in test ponds provides only a snapshot of the variability that probably exists in these systems. However, the data suggest that biochemical oxygen demand may be substantial throughout the year in the zone just above the interface with MFT.

vii) Metals and Metalloids

Metals constitute most of the inorganic elements present in mineral ores while metalloids describe the elements sharing characteristics with both metals and non-metals. Trace metal scans measure the full suite of metals and metalloids present in the environments surrounding ores, such as in ground and surface waters, plants and animals. Trace metal scans of test pond surface waters indicated that the heavy metals of primary environmental concern, such as mercury and cadmium, were not present at detectable levels (Table 2). Other trace metals such as aluminum, boron, lithium and strontium were elevated in cap water and may be particularly associated with MFT pore water or the oil sands geology in general. Typically, metals will adsorb to sediments and stay associated with particulates rather than water; therefore, particulate removal from the water could in turn influence metal removal, provided the sediments are not subject to disturbance by wind action. In general, metals have a complex environmental chemistry and toxicology which varies considerably depending on their ionic state.

Levels of aluminum, arsenic, iron and selenium exceeded Canadian guidelines for the protection of aquatic life in some test ponds, but there were no clear relationships with presence or absence of MFT or OSPW. Aluminum is a common constituent of clay soils and at least some of the elevated values may be related to leaching from excavated basins. Arsenic peaks were limited to early years of sampling, suggesting that they were associated with suspended particles present shortly after excavation. Arsenic did not show similar peaks in WIP pore water samples. Similarly, comparison of iron and lead values for test ponds and WIP MFT suggest that elevated concentrations in some test ponds may also be more related to weathering of soils and suspended particulates in the water cap than release of these elements with pore water.

Boron exceeded guideline values for long-term exposure of aquatic life only in those test ponds with OSPW (Ponds 5, 9 and 10). Comparisons with values for reference lakes also indicate that it is elevated in the reclaimed environments. Boron in Sucker and Kimowin Lakes averaged 0.04 mg/L, compared to 0.11-1.92 mg/L in the test ponds. Marine clays like those characterizing the oil sands are known to be rich in boron. Similarly, lithium in reference lakes averaged 0.01 mg/L and strontium ranged from 0.096-0.138 mg/L. Lithium in test ponds with a natural surface water cap was similar to the reference values (0.02-0.04 mg/L), but elevated in test ponds with OSPW (0.12-0.18 mg/L). Strontium was also elevated in ponds with OSPW (0.49 mg/L). National guidelines do not exist for lithium and strontium. Metals scans of WIP pore water indicate elevated levels of these three metals, suggesting that the MFT is one source material, but the presence of OSPW appears to be the greatest influence on absolute values in test ponds.

### Example 4

### Chemical Exposure and Toxicity in Aquatic Life

Ecosystem viability in water capped test ponds was evaluated using three main study approaches: assessments of direct toxicity to individuals of a species such as yellow perch; assessments of community structure in a group of species, such as phytoplankton or benthic invertebrates; and assessments of food web structure using stable isotopes of carbon and nitrogen.

i) Exposure, Uptake and Bioaccumulation of Organic Constituents

When rainbow trout fingerlings were exposed to aged OSPW from Pond 9 for four days, naphthenic acids were detected in flesh samples, but no lethality to the exposed fish was seen. Pond 9 contains no MFT (OSPW only) and concentrations of naphthenic acids in the water were about 15 mg/L. The OSPW had weathered in Pond 9 for about 13 years and the naphthenic acids remaining would be representative of the refractory fraction and breakdown products from the labile fraction. Further exposures of rainbow trout to commercial naphthenic acids established that fish took up naphthenic acids, and then rapidly excreted 95% of the total amount after one day in clean water. Similar studies with wetland plants indicate very little uptake of naphthenic acids by plant species.

Early studies of caged rainbow trout found that fish in all test ponds were being exposed to PAHs, as indicated by elevated cytochrome P450 activity and bile metabolites; this included fish in Pond 1 which contains no MFT or OSPW in a clay overburden basin, Yellow perch stocked in Demonstration Pond also showed induction of liver cytochrome P450 and PAH metabolites in bile, and perch in an overburden basin with no MFT or OSPW (South Bison Pond) showed elevated exposure compared to those in the MFT-capped test pond. These results suggest that PAHs were originating from bitumen, which tended to be more prevalent in unprocessed soil materials (those not subject to bitumen extraction) than in MFT.

Further evidence of greater exposure to PAHs from unprocessed soil was seen in studies with tree swallows and benthic insects sampled from a variety of reclaimed systems (including South Bison Pond, Demonstration Pond and Pond 7). Bioaccumulation in benthic insects was species-dependent and low overall; median biota-sediment accumulation factors (BSAFs) ranged from 0 to 2.33 and were lower for the parent PAHs than for their alkylated forms. Many of the BSAFs for parent PAHs in Demonstration Pond were less than one, suggesting that the presence of MFT may make these PAHs less available for uptake into tissues (bioavailable) due to strong sorption to fines or encapsulation in immobile bitumen particles.

A study of lake trout in the Lake Superior ecosystem indicates that some of the parent PAHs present in MFT water capped systems would have bioaccumulation factors of 1.95 to 4.73. Different fish species and food chain lengths will affect these values and their application to MFT water capped systems.

Thus, although PAHs and their breakdown products are not readily released from MFT to water, they do enter water caps from other sources, such as reclaimed soils. Their uptake could elicit toxicity responses in fish or lead to the transfer of PAHs to wildlife, particularly where there are long-lived fish species.

Fish tainting is another indicator of the accumulation of petroleum-associated chemicals in animal tissues. There is some indication that naphthenic acids, PAHs and constituents of un-recovered bitumen may contribute to the smell and flavour of fish from some waterways in the oil sands region.

ii) Characterization of Toxicity

When the water capped test ponds were initially constructed, some acute toxicity to fish remained for a few months in Pond 5, which contains MFT capped with fresh OSPW. Acute toxicity refers to responses that occur rapidly with exposure, last a short time (hours to a few days), and result in mortality. Ponds 2, 3 and 4 containing MFT and a natural surface water cap showed no acute toxicity to rainbow trout or bacteria (Microtox™ assay) from the outset. The presence of oxygenated waters (aerobic) appeared to be essential for the loss of toxicity. Naphthenic acids were identified as the main acutely toxic constituent in OSPW; fresh OSPW produced a fish LC₅₀<5 mg/L, while aging OSPW in outdoor systems for a year or more reduced mortality to LC₅₀>40 mg/L.

After a few months at most in test ponds, any toxicity expressed by fish was chronic rather than acute and was observed by altered reproductive effort, as indicated by smaller sex organs, reduced secondary sex characteristics, lower sex hormone levels and/or reduced egg laying; altered early development, as indicated by lower hatching success, deformed embryos and/or smaller eggs and fry; altered respiratory capacity, as indicated by changes in gill structure; altered disease resistance, as indicated by viral tumours and skin lesions; and altered general stress levels, as indicated by blood cell counts and histopathology.

When test ponds were constructed and filled, forage fishes (fathead minnows, chub, stickleback, suckers) were introduced incidentally with the water for the cap and some survived for one or more seasons. Caging and laboratory studies with fathead minnows have since indicated altered reproductive effort with exposure to aged waters from the test ponds. In 1995, it became evident during trapping studies that fathead minnows in Demonstration Pond (MFT bottom with natural surface water cap) had not reproduced in 1994 or 1995. Laboratory studies also indicated that female minnows exposed to OSPW took longer to produce their first clutch of eggs and produced fewer clutches in a given breeding season; the males exhibited delayed development of tubercles, which are secondary sex characteristics important during mating.

In 2004, a series of laboratory studies was initiated to follow up on the fathead minnow reproductive effects observed almost a decade earlier. Spawning of minnows in waters from Demonstration Pond (MFT bottom, natural surface water cap) and Pond 5 (MFT bottom, OSPW cap) was equivalent to that in water from a reference, Gregoire Lake, whereas spawning in Pond 9 (no MFT, OSPW cap) was significantly reduced. Females also had smaller ovaries and males had fewer numbers of nasal tubercles upon exposure to Pond 9 water. The addition of salts to reference water produced similar effects to those observed in the Pond 9 treatment. However, when individuals were held in saline water for several months prior to reproduction, the negative reproductive effects disappeared. These data suggest that elevated salinity in water caps influences the reproductive effort of fathead minnows, but individuals may become acclimated to the condition, and other toxic elements may be interacting with salts to produce the impairment. Total naphthenic acids present in Pond 9 water were in the range 30-40 mg/L, whereas those in Demonstration Pond and Pond 5 were less, 7-10 and 15-20 mg/L, respectively. PAHs in water or tissues were not measured during this study, but early surveys showed total PAHs would likely be in the <1 μg/L range in water.

In 2001, goldfish were caged in Ponds 1 (no MFT, no OSPW), 3 (MFT, natural surface water cap) and 5 (MFT, OSPW cap) and monitored for steroid hormone levels. As with the later fathead minnow studies, this experiment suggested that reproduction may be impaired upon exposure to a combination of MFT and OSPW (Pond 5) but not with MFT alone (Pond 3). In Pond 5, plasma concentrations of the main sex hormones testosterone and 17β-estradiol were reduced in goldfish after 19 days. Follow-up in vitro studies indicated that the reduced levels were the result of a restricted capacity to produce steroid hormones in male and female fish. Yellow perch stocked into Demonstration Pond in 1995 also showed reduced levels of these two hormones. In both perch and goldfish, the greatest impact seemed to occur during fall recrudescence. Neither study found any coincidental change in testes or ovary sizes. The goldfish studies tried and failed to elicit these hormonal responses by exposing fish to a naphthenic acid extract from OSPW, suggesting that naphthenic acids are not the constituent affecting hormonal cycles in that species.

Although abnormal hormonal cycles and reduced reproductive output are appropriate indicators of stress in fish populations exposed to chemicals, these effects do not necessarily preclude population survival. However, depending on the severity of the responses, they may make populations less fit to compensate for additional natural stressors, such as periods of low dissolved oxygen in winter or high temperatures in summer. The population size of forage fish in test ponds has not been routinely monitored; there is anecdotal evidence for population crashes and recoveries. For instance, sticklebacks were introduced to test ponds but have disappeared over time. The population of fathead minnows in Demonstration Pond appeared reduced in the late 1990s, but has since recovered. There is insufficient evidence to link these trends to direct toxicity, reproductive or otherwise.

The early development of fishes is often considered to be the life stage most sensitive to chemical stressors. Developing yellow perch and Japanese medaka were assessed for impacts of water cap constituents. In 1997, yellow perch eggs were collected from Demonstration Pond and the Mildred Lake freshwater reservoir and evaluated in the laboratory for fertilization, hatching success and larval growth. Although there was no deleterious effect on fertilization rates of eggs laid in Demonstration Pond water, there were increases in post-fertilization mortality of embryos (27% versus <1% in Mildred Lake water) and decreases in larval size (both length and weight). In another experiment, perch eggs were fertilized in the laboratory and exposed to a wider variety of water caps from the test ponds. Neither fertilization nor embryo mortality was affected, but water exposure to those ponds having an OSPW cap (Ponds 5, 9, 10) produced smaller eggs and shorter larvae. Both size parameters were significantly related to salinity (measured as conductivity) and total naphthenic acids concentrations. The larval growth effects were also observed in caged fathead minnows in Demonstration Pond for 21 days; larval growth slowed significantly from the pre-exposure rate. If populations are not able to compensate for lower larval production or smaller size of individuals, they may be at greater risk of dying out during high stress events. Evidence from the stocking research suggests that yellow perch and fathead minnows in Demonstration Pond continued to grow at a slower rate than cohorts in Mildred Lake or other reference lakes in the region.

A non-native fish, Japanese medaka, was used as a surrogate for yellow perch, because its life history makes it easier to perform multiple tests in a short time period. Both species were used in lab assays with a naphthenic acid extract of MLSB water; these tests found that the naphthenic acids present in fresh OSPW produce embryo deformities (misshapen heads, curvature of the spine, reduction in tail length) at concentrations over 7.5 mg/L, and retarded larval growth at concentrations over 1.9 mg/L. The two species showed similar effects, but yellow perch were more sensitive than medaka. Deformities were predominantly evident in the eyes and the skeleton. Eye and spinal deformities are consistent with blue sac disease, which also commonly involves edema in the yolk sac and body cavity. Increased incidence of blue sac disease was evident in medaka exposed to another extract of the particulate component of fresh MLSB water. Parallel assessments of commercial PAHs (alkylated dibenzothiophenes found in OSPM) found the same elevated incidence. A concentration of 13.9 μg/L total PAHs was sufficient to induce blue sac disease in developing fish embryos. When the MLSB extract was exposed to ultraviolet light, as would be expected to occur in the water caps, the mortality and deformity rates were elevated further.

Throughout the 15-20 years of monitoring in test ponds, alterations in gill structure of fishes have been the most consistently reported indicator of toxicity. Immature rainbow trout caged in Ponds 2 and 5 in the early 1990's had inflamed primary gill arches. Yellow perch exhibited large aneurysms and a proliferation of chloride and epithelial cells in the interlamellar spaces of gills after 3-10 months living in Demonstration Pond. Five years later, yellow perch and goldfish caged in Pond 5 showed the same histopathology after a 3-week exposure; microscopic analysis of gills showed epithelial cell necrosis and mucous cell proliferation. Although Demonstration Pond was not re-sampled, fish caged in Pond 3, which similarly contains MFT capped with clean surface water, showed insignificant alterations to gill structure, suggesting that either weathering leads to removal of this form of toxicity from water capped systems not influenced by OSPW, or that a three-week exposure was not sufficient to induce these responses.

The presence of gill aneurysms indicate that the fish gills are damaged; the proliferation of chloride cells are an indication that the test fish is trying to maintain the ionic integrity of the gill structure by blocking the physical uptake of more chemicals from the water. Without blocking the gill surface from further uptake, physiologically important ions will leak across the gill membrane and be lost. The blockage also makes it more difficult for oxygen to diffuse into the body for respiration and individuals may experience respiratory distress. Measures of gill dimensions of the caged fish indicated that gas exchange across the gills was impaired by the cellular changes. However, the blocking was effective in maintaining ionic balance within the body, as circulating concentrations of sodium, calcium and chloride in the blood of stocked yellow perch were not diminished. Ultimately, these structural changes would affect the individual's ability to breathe, and where dissolved oxygen levels become low (i.e. under ice or in systems with a high biochemical oxygen demand) the condition could lead to suffocation and death.

In an attempt to establish a causative link with chemical constituents of test pond water caps, laboratory tests examined the effect of exposure to a naphthenic acid extract from fresh WIP MFT release water on perch gill structure. One-year old yellow perch exposed for three weeks showed the same elevated incidence of gill pathology seen in test pond-exposed fish. The addition of sodium sulphate to the extract solution exacerbated the expression of toxicity. Sulphate and naphthenic acids comprise two of the main constituents of concern in capping water and may act in concert to induce gill damage. The resulting reduced gill surface area likely led to restricted transport of both naphthenic acids and oxygen into the perch body. Ultimately, a single causative agent was not identified; however, it is clear that such an agent is not restricted to MFT water capped systems, since the same gill histopathology was observed in fish from other reclaimed systems, such as South Bison Pond which had a surface water conductivity of >1500 μS/cm and naphthenic acids of 5-10 mg/L. The earlier field study speculated that PAHs play an important role in the gill damage as well. The gill aneurysms presumably occur because the outer layer of the gill has been damaged. This layer contains the cytochrome P450 enzymes described earlier that respond to PAHs, which may indicate a susceptibility to PAH exposure in these cells.

The stocking of yellow perch in Demonstration Pond in 1995 allowed some unique evaluations to be made with a top predatory fish that were not possible with short-term caging or laboratory studies. The extended, full life cycle exposure allowed for the assessment of multiple stressor effects, developed from living in a young, establishing environment with chemical challenges. Some indicators of chronic stress became evident that were not seen in shorter, more controlled experiments. For instance, symptoms of disease appeared as elevated rates of fin erosion and lymphocystis-like lesions in adult perch. The origin of the lesions was unknown. A second stocking of yellow perch conducted during the summer of 2008 again found lesions and fin erosion. Skin samples were collected and analyses confirmed that these lesions are lymphocystis viral-induced. Degenerative lesions were also observed in livers of caged perch and goldfish held in Pond 5. The types of lesions were consistent with those described in other regions and species with exposure to petroleum hydrocarbons.

iii) Bioaccumulation and Transfer of Impacts to Terrestrial Wildlife

Tree swallows in the vicinity of the MFT water capped test ponds (boxes were adjacent to Demonstration Pond) showed relatively minor effects on disease-resistance, stress-induced mortality and reproductive success, Tree swallows nesting at Demonstration Pond were more heavily infested with blow fly larvae than those nesting at the reference area, Poplar Creek. Although blow flies are a common inhabitant of swallow nest materials and parasite of nestlings, the intensity of the infestations at reclaimed sites (including some Suncor wetlands) was great and appeared to impact negatively on nestling growth, as measured by reduced mass and wing length. However, nestlings at Demonstration Pond were still able to withstand a severe stress event brought on by extreme weather, experiencing mortality similar to reference nest box populations. Nestlings at other reclamation sites experienced 90-100% mortality during the same weather event. Total nest success, a measure combining hatching and fledging success, was significantly less in that particular storm year (2003) than nest success at Poplar Creek, but greater than at other reclamation sites. Thus, the incidence of blow flies may be a good indicator of the potential for stress-induced mortality in young swallows, and indicates that the risk to swallows associated with water capped MFT systems is low relative to other reclamation systems.

In a nestling study at Poplar Creek, tree swallow young injected with naphthenic acids exhibited few biochemical responses. Nestling growth, blood chemistry, organ weights and cytochrome P450 enzyme activity were not affected by dosing with a concentration estimated to be a 10-fold worst-case scenario, suggesting that naphthenic acids pose little risk to developing swallows.

Similar dosing studies of small mammals with naphthenic acids were undertaken to gauge whether a drinking water source for this chemical family would affect survival, fecundity or biochemical indicators. Laboratory rats received extracts of fresh WIP surface water at a range of levels estimated to represent the range expected from incidental exposure in a reclaimed landscape. While the naphthenic acids were not representative of the composition of aged OSPW or MFT release water, this experiment tested a plausible exposure scenario, where the lab rat was a surrogate for regional mammals such as the ecologically important northern red-backed vole. The detection of some sub-chronic effects in the liver of these rats at the highest extract concentration suggests that there is a small potential for liver damage in rodents with exposure to surface water from water capped systems. In addition, an altered behavioural tendency to drink more, presumably due to the elevated salt content of the water extract, has the potential to exacerbate chronic toxicity effects. A stimulation to keep drinking will increase the uptake of organic constituents and metals, thereby increasing bioaccumulation and exposure over a lifetime. Herbivores such as moose and snowshoe hare that alternate seasonally between woody and green forage foods may be attracted to the salt water, as to salt licks in the spring.

### Example 5

### Littoral Zone Development

The littoral zone of a lake is the productive, shallow water zone bounded by the depth to which light can penetrate and rooted plants can grow. The test ponds cannot be used to fully address issues regarding littoral zone development, because their water caps are shallow (<3 m) and light can penetrate to most of the bottom sediments. In this region of the northern boreal forest, natural lakes have littoral zones covering 9-30% of the lake area. Modeling suggests that an operationally acceptable littoral zone area for water capped lakes would fall at the low end of this range, around 8 to 10%. The test ponds were effectively 100% littoral zone, acting more like wetlands than a lake.

The range of littoral zone slopes was limited in the test ponds due to pond locations and constraints created by the goals of the research. They generally fell within the 6-10% range, which is roughly representative of Base Mine Lake shoreline gradients but steeper than the 0.5-2% deemed optimal for establishment of many macrophytes. However, macrophytes have established in the test ponds, beginning the first year after construction. The total mass of macrophytes during these early years was low compared to natural lake systems, possibly due in part to turbidity and limited nutrients.

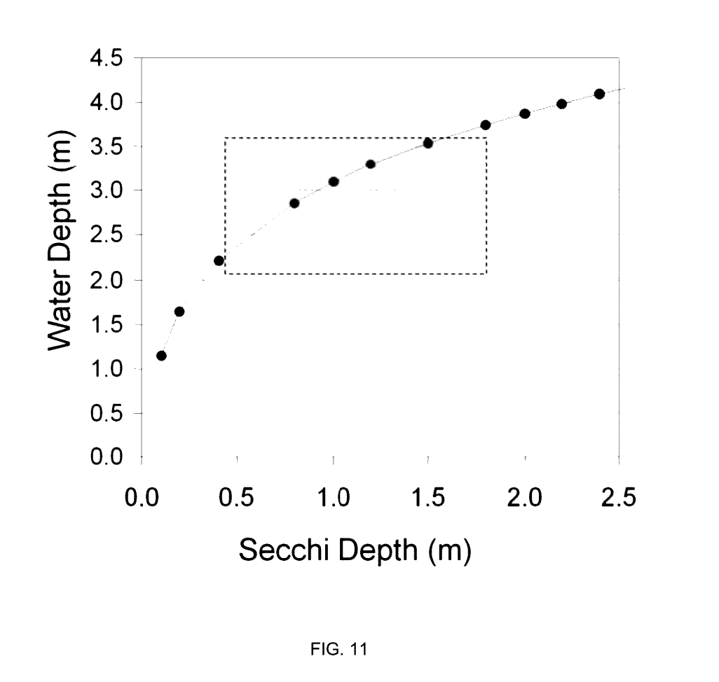

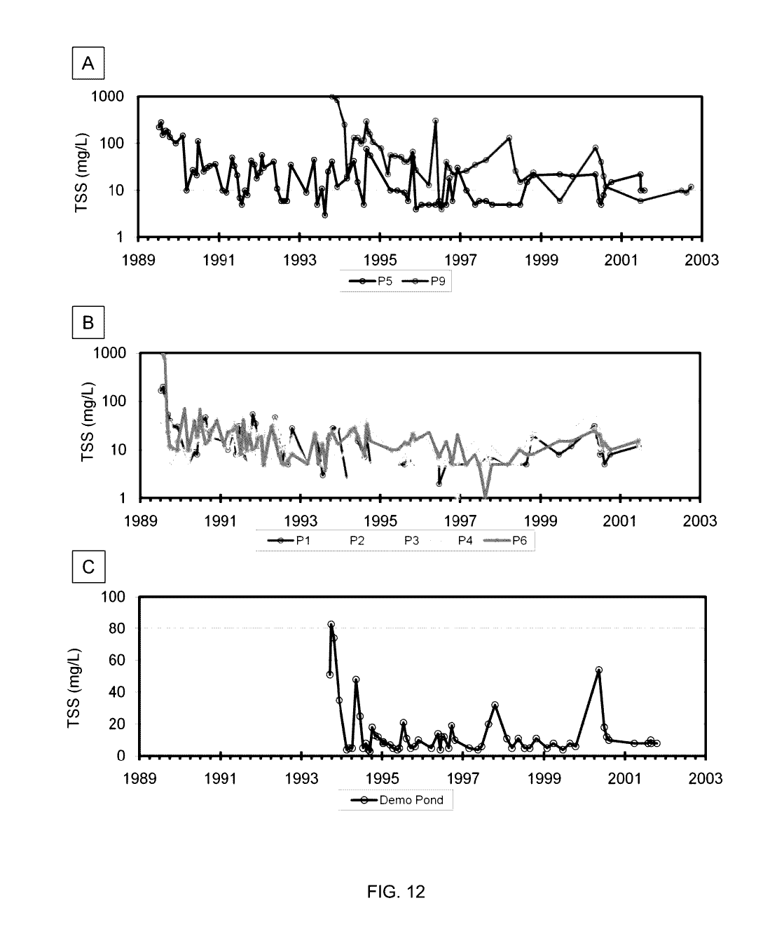

The pattern of water clarity in various seasons has been monitored in test ponds by measuring secchi depth and total suspended solids (TSS). Secchi depth is a simplistic measure of overall light penetration that has been related specifically to maximum depths for macrophyte establishment in lakes (FIG. 11). The range of secchi depths measured in Demonstration Pond over the summer months suggest that light would not be a factor preventing the colonization of rooted plants up to the maximum depth in the pond of 3.6 m. Total suspended solids is a more quantitative measure of particulates in the water column, both sediment-derived (including mineral clays and organic detritus) and algal-derived. Repeated measures of suspended solids in the water caps of the test ponds indicate some turbidity during the first year following construction, then few isolated events thereafter (FIG. 12). Of the smaller test ponds containing MFT and an initial natural surface water cap (panel B), Pond 6 showed a more extreme start-up spike in suspended solids than was seen in the similarly-constructed ponds. This was likely a reflection of the algal bloom observed and related to fertilization of this pond during the first summer season. Pond 9, containing OSPW with no MFT bottom (panel A), showed the most persistent, sporadic turbidity. Since particulates from OSPW are known to largely settle out within a week under quiescent conditions, persistent sporadic turbidity events after the first year were most likely related to the exposed clay basin materials. After excavation and before filling, the basin of Pond 9 was not amended with organic soils, and clay fines would remain susceptible to wind-induced suspension. Relatively minor turbid events were observed during biological studies in Demonstration Pond during the summers of 1995 and 1996. There is some indication that these events were unrelated to MFT and were the result of wind-induced clay re-suspension in the shallow littoral zone above the level of MFT. The clay overburden in which Demonstration Pond was excavated contains a high silica content, similar to glacial rock flour in alpine lakes, and appears to re-suspend more readily than other clay materials. This silica is not prevalent in the clay of the Base Mine Lake basin.

The texture of lake sediments is another key determinant of macrophyte growth, because it influences the ability of plants to root. In a comparison of potential substrates composed of tailings sand amended with peat, black clastic clay, pink clay or natural lake sediment, the amended sand produced macrophyte growth most comparable to the natural sediment. Although fine pink clays produced good growth, they also tended to re-suspend with disturbance, thereby reversing any growth advantage. None of the engineered sediments could fully match the quality of a reference, natural lake sediment for root growth. However, where macrophytes can become established, detritus will accumulate over time on the bottom and continually improve the textural quality.

Although there is little information available on the effects of water chemistry in MFT water capped systems on macrophytes, literature indicates that some boreal lake and wetland macrophytes are sensitive to dissolved salts. A limited amount of research in reclaimed wetlands in the oil sands, including Bill's Lake (a marsh) on the Mildred Lake lease, suggests that macrophyte diversity in reclaimed systems may be limited in part by a lack of seed sources for sub-saline water plant species in the immediate vicinity of reclamation sites. Species which disperse by mechanisms other than wind may be particularly limited in their ability to colonize new reclaimed environments, making direct planting or seeding the only mechanisms available for their establishment in created sub-saline lakes and wetlands.

Inorganic phosphorus and nitrogen are key limiting nutrients for primary production in aquatic food webs, directly influencing plant production and biomass, as well as sedimentary accumulation of carbon-rich detritus. A small number of fertilization experiments were conducted in test ponds and these contribute to understanding of nutrient cycling in water capped systems. Pond 6, containing MFT capped with natural surface water, was fertilized with ammonium phosphate six times (<0.5 mg/L N and P) during the year of construction and one year after. The intent was to evaluate the effect of this initial fertilization on rates of primary productivity and detritus build-up at the MFT-water cap interface. The total phosphate concentration in the water cap dropped by over half within hours following each fertilization, suggesting rapid sorption to MFT, uptake by plants and bacteria, or a combination of sorption and uptake. Algal populations increased markedly, and an increased accumulation of detritus at the water-sediment interface was also evident after 2 years. Five years after construction, it appeared that the Pond 6 algal community was solely phosphorus-limited, whereas algal growth in unfertilized test ponds was limited by both phosphorus and nitrogen. The current nutrient limitation status of this and other ponds is unknown, but research in other reclaimed waters of the oil sands suggests that reclaimed systems are relatively phosphorus-poor compared to natural systems in the boreal region.

The early samples of nitrogen and phosphorus in developing water caps showed relatively low concentrations, potentially due to initial sorption of nutrients to MFT. However, primary productivity has remained low in Demonstration Pond, which is considered oligotrophic according to chlorophyll-a standard productivity measures. Follow-up nutrient analyses were not conducted until 2001, and then only in a few test ponds. In Ponds 1, 3, 5 and Demonstration Pond, total nitrogen and phosphorus concentrations in the water caps were essentially unchanged from 1994 values (Table 3). Fertilization experiments were initiated in the summer of 2007147, but in the absence of a clear understanding of the range in background nutrient levels.

TABLE 3
Nutrient concentrations in MFT water capped systems148

| | Total nitrogen | Total phosphorus |
|---|---|---|
| System component | (TKN, mgN · L−1) | (TP, mgP · L−1) |
| MFT pore waters | 12 | 0.2 |
| Test pond surface waters | 0.5-1 | 0.01-0.05 |
| Reference lake surface waters | 0.5-6.5 | 0.01-0.3 |

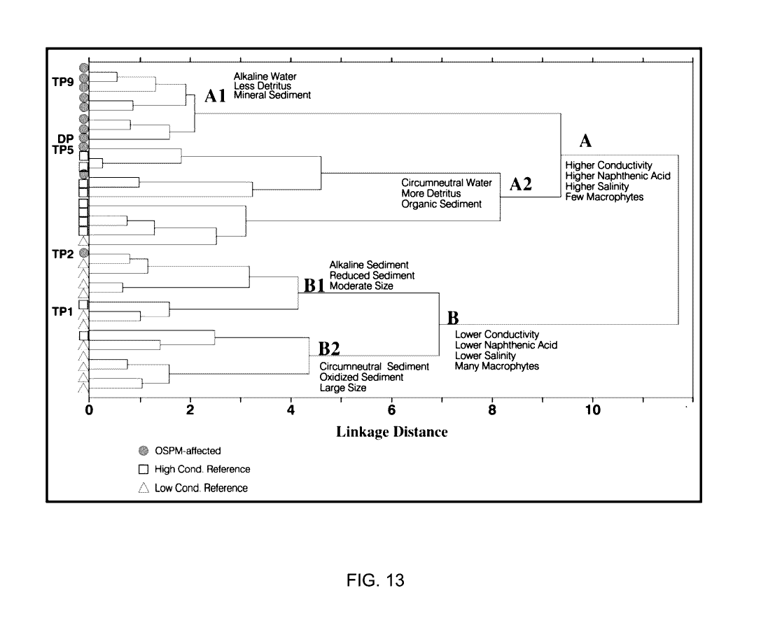

Littoral zones are also a key habitat for benthic invertebrates, which are the bottom-dwelling lower animals like insects, clams, snails, worms, leeches and crustaceans. The quality of habitat for benthic invertebrates was evaluated in 30 water-bodies in the oil sands region, some of which were considered to be unaffected by development and some of which were reclaimed (FIG. 13). The benthic communities in the reclamation reference, Pond 1, and in Pond 2 (MFT+natural surface water) were similar in composition to communities in regional reference locations. The communities in OSPW-influenced Ponds 5 and 9 and in Demonstration Pond (MFT+natural surface water) were dissimilar to reference communities and clustered in a grouping with other communities present in systems influenced by OSPM. These groupings illustrate that both physical and chemical factors affect habitat quality for benthic invertebrates. While toxicity of naphthenic acids may affect littoral zone biota, the quality of the sediment and amount of detritus may be just as or more important in determining overall habitat quality and thus the abundance and diversity of the benthos. These findings on key habitat drivers are consistent with those for studies in regional natural water bodies. The results also illustrated that terrestrial soils will not provide the full complement of materials needed for good quality benthic habitat, but must be supplemented, either naturally over time or through accelerated means, with materials from aquatic decay.

### Example 6

### Lake Ecosystem Viability

One of the communities first observed in water capped test ponds was phytoplankton. Surveys of this plant community in test ponds were conducted repeatedly in 1990, 1993-95, 1997 and 2001. It was found that total biomass of the community may be greater in younger, more impacted water caps, but diversity is reduced. Acclimation to process-affected water can occur in the community. The influences of naphthenic acids and salts on community structure can be distinguished from each other and threshold values derived for each independently. With reducing salinity and naphthenic acids, both diversity and abundance become similar to those for natural water bodies of the region.

Phytoplankton studies used a combination of direct sampling of communities in test ponds and in situ (on-site) microcosm studies. Microcosms are a form of enclosure, in this case set into the study ponds. They allowed for the control of two critical environmental factors, namely herbivores (zooplankton) and nutrients. The phytoplankton studies also encompassed a much wider array of impacted waters than just MFT water capped systems. These studies found that test ponds with MFT bottoms and natural surface water caps (Pond 3 and Demonstration Pond) contained phytoplankton communities indistinguishable from reference communities in Mildred Lake (FIG. 25)153. Test ponds with an OSPW cap (Ponds 5, 9) contained less diverse communities, but total abundance was not different.

Microcosm experiments were critical to identifying the roles that naphthenic acids and salts play in determining the community composition of phytoplankton. In tests where a standard plankton inoculant was introduced to a number of test waters and exposed to a dose of naphthenic acids, researchers found that 24.5 mg/L of naphthenic acids extracted from fresh WIP OSPW was sufficient to produce a lag in the population growth of the community. Growth lags are important because they shorten the season for primary production in temperate climates and limit food availability up the food chain early in the season. However, higher concentrations of naphthenic acids (50 and 180 mg/L) eventually produced the highest biomass of phytoplankton. An assessment of the species composition of these communities showed that the increased mass was related to taxonomic succession. Biomass increased as selection for a few species tolerant of naphthenic acids occurred and these few species proliferated in the absence of competition.

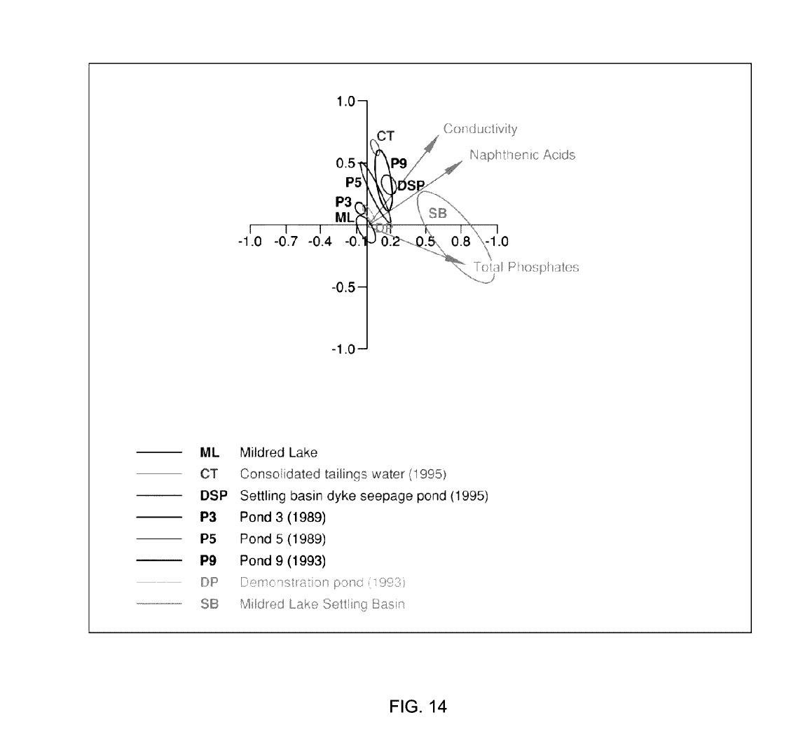

The phytoplankton species most tolerant of naphthenic acids and salts were identified (FIG. 14), Naphthenic acids began to exert an influence on community composition at 20-30 mg/L in test pond microcosms, while the corresponding threshold for salt effects occurred at a conductivity of 1000 μS/cm. The naphthenic acid threshold is higher than the concentrations measured in MFT test ponds with natural surface water caps (<15 mg/L), but within the range found in test ponds using OSPW as the cap (15-35 mg/L). The latter OSPW-affected ponds were also within the salinity range for effects (conductivity >2000 μS/cm) after 5 years of aging. Species tolerant of elevated concentrations of naphthenic acids and major ion species, sulphate and chloride, are listed below:

| Naphthenic Acids | Sulphate | Chloride |
|---|---|---|
| Glenodinium spp. | Botryococcus braunii | Ceratium hirundinella |
| Gymnodinium spp. | Rhodomonas minuata | Cyclotella spp. |
| Gloeococcus schroeteri | Scenedesmus | Euglena spp. |
| Cosmarium depressum | quadricuada | Schroederia spp. |
| Chrysococcus rufescens | | |
| Chromulina spp. | | |
| Ochromonas spp. | | |
| Keratococcus spp. | | |
| Peridinium cinctum | | |

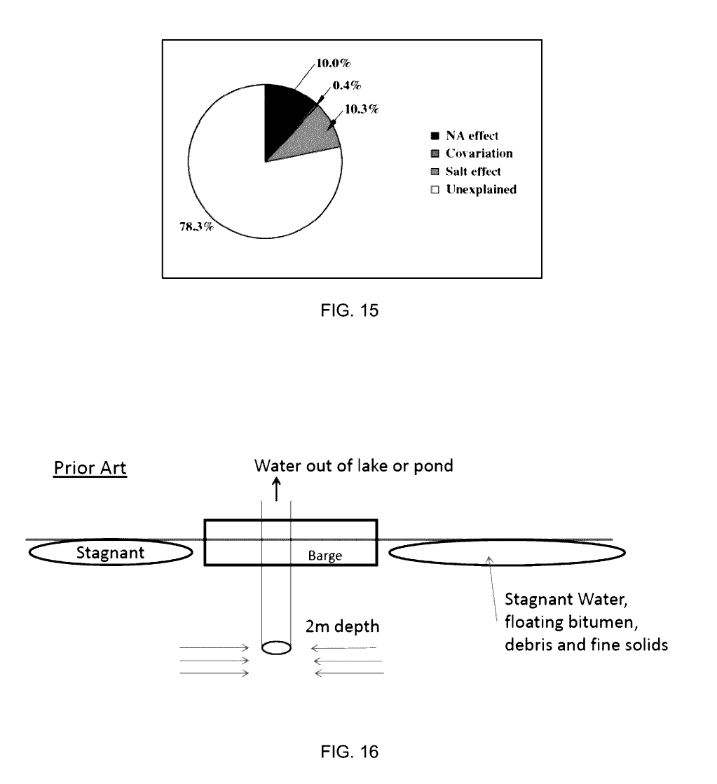

Even though these chemical constituents exerted strong and statistically significant effects on algal community diversity, there was still considerable variability in community makeup that could not be explained by chemical concentrations. This illustrates the complexity of environmental factors that control phytoplankton communities in boreal lakes and wetlands (FIG. 15).

A key group of grazers on phytoplankton in boreal ponds and lakes are the zooplankton. Community composition was altered in water capped systems compared to regional reference waters. Abundance was negatively affected by elevated naphthenic acids concentrations. The zooplankton community in Pond 3 (MFT with a natural surface water cap) eight years after construction was very similar to the one sampled in Mildred Lake. However, in Pond 5 (MFT with OSPW water cap) a relative scarcity of one of the groups of zooplankton, namely the rotifers distinguished the community from the reference in Mildred Lake. Throughout most of the summer season of the surveys, the biomass of zooplankton in MFT basins capped with either natural surface water or OSPW was not different than that measured in the reference systems. The strength of the association between naphthenic acids, salts and community composition was strong, with the two chemical constituents explaining up to 80% of the variability in species assemblages. A threshold range for effect was estimated at 1.1 to 9.0 mg/L total naphthenic acids.

Benthic invertebrates live close to, on or in lake sediments, and provide a full complement of functional groups (grazers, scavengers and predators) within the one community. They are a critical food source for fish and wildlife. Although larval fish will forage extensively on zooplankton, adults typically depend on benthic invertebrates or smaller forage fish as their main food resource. In an extensive survey of water bodies in the oil sands region, the richness (total number of species present) of benthic communities was primarily influenced by water pH, concentrations of total naphthenic acids and salts, abundance of detritus and sediment phosphorus levels. Abundance or biomass was more strongly linked to the extent of macrophyte development, salinity (which strongly impacts macrophyte diversity) and abundance of detritus. In reference systems unaffected by development, the age at which the benthic community seemed to attain peak diversity and abundance was 5 years; reference systems younger than 5 years were incomplete in the representation of taxa and in the density of biota. When compared to young reference water-bodies, the young basins or wetlands in reclaimed landscapes were not as diverse, but had equally abundant assemblages. The invertebrate groups characteristic of young, establishing, and old established reference water-bodies were as follows:

The MFT test ponds with natural surface water caps contained benthic invertebrate assemblages that exhibited greater diversity and biomass than other examined reclaimed systems. They were within the range of values observed in low conductivity reference systems. These measures were based on samples taken in 2001, when the test ponds were 8-12 years old.

In an earlier survey of Demonstration Pond, the benthic community was found to be small, both in biomass and number of species compared to communities in lakes well removed from the oil sands. In 1996 and 1997, the benthos density in Demonstration Pond was <35% that of communities in Mildred, Sucker and Kimowin Lakes. At that time, the benthic community in Demonstration Pond was dominated by midges and mayflies, whereas reference assemblages additionally contained significant numbers of burrowing worms, snails and amphipods. There was evidence then that turbidity issues and predator-prey dynamics were impacting the development of the benthos. Coincidental low abundances of phytoplankton, zooplankton and macrophytes in those years suggested that turbidity and/or toxicity issues were producing a chain reaction of limited resources throughout the food web. Additionally, stomach content assessments of yellow perch in Demonstration Pond suggested that a forage fish base (fathead minnows) became severely depleted in those years, and stocked perch had switched to benthos, further depleting that community as well.

When yellow perch were first stocked into Demonstration Pond, a suite of indicators of energy storage and utilization suggested that they experienced improved food availability or reduced competition in the stocked pond compared to the original population in Mildred Lake. Size of reproductive organs was greater, spawning occurred every year rather than every other year, and survival and condition of adults was high in the stocked population. However, the benthic invertebrate surveys indicate that the presence of a large fish predator in the test pond was placing a stress on the prey communities at lower trophic levels.

Macrophyte and benthic invertebrate diversity in MFT water capped systems may also be limited by factors completely unrelated to the oil sands. Recruitment of these communities into new water-bodies is controlled by the dispersal capacities of each species, and the geographic distances and linkages to source populations. In the absence of surface water linkages, colonization of new environments may be limited to plant species with wind-dispersed seeds and invertebrates with a flying stage in their life cycle. Some evidence suggests that saline-tolerant plant species assemblages may be too distant from the Syncrude lease to allow natural colonization of the sub-saline aquatic reclamation sites.

A potentially important group that has not been well surveyed in test ponds is the amphibians. Broad surveys in the region suggest that endangered Canadian toads do inhabit the area and use Demonstration Pond for breeding. However, amphibians in general are poor osmoregulators (the regulation of an internal salt balance) and thus highly sensitive to elevated salinity.

Beginning in 2000, stable isotope studies of carbon, nitrogen and sulphur were conducted in test ponds. In comparisons with regional reference systems, carbon signatures for sediments, plankton, macrophytes, invertebrates and fish were not different in MFT water capped systems, suggesting that the constituents of MFT are not a significant source of carbon for the food web. However, nitrogen signatures were different in the test ponds and researchers speculated that nitrification of ammonia from MFT to nitrate and nitrite in the aerobic water caps was providing a substantial additional source of nitrogen to food webs in these systems. Because the process of nitrification will likely be more prominent in the early development of water capped systems, the availability of this source of nitrogen can be expected to change over time. Sulphur signatures also varied in relation to the sulphate concentration in test pond waters, suggesting uptake by organisms.

In an independent study where microbial communities were evaluated, microbial biofilms in Pond 9 (no MFT, OSPW cap) were found to source 68% of their carbon from bitumen in the ecosystem. Additionally, evidence was found for the transfer of carbon and nitrogen assimilated by microbes to invertebrates such as aquatic insects and water fleas. Older water-bodies had higher levels of dissolved organic carbon than younger water-bodies. Older systems also showed increased uptake of carbon by bacterioplankton.

The discrepancies between these findings illustrate that there are still challenges in interpreting stable isotope signatures in water capped systems. The cycling of carbon and nitrogen as the ecosystems age remains poorly tracked. In addition, the critical signatures of various microbial and plant communities (macrophytes and phytoplankton) have been inconsistently measured, yet provide the greatest information about energy sourcing at the foundation of the aquatic food web.

Although the individual studies of ecosystem development in test ponds have been well carried out and there is a high level of confidence associated with many of their findings, most were not designed to answer specific questions about the viability of MFT water capped systems as opposed to aquatic reclamation strategies in general. There were few comparisons of communities among the original seven test ponds, having various combinations of MFT bottoms and water caps (phytoplankton studies were the exception). As a consequence, uncertainty remains about the influence of MFT alone and in combination with OSPW on ecosystem development. In a lake ecosystem there will be additional drivers of abundance, diversity and productivity that were not present in test pond systems. These include nutrient cycling from shallow to deep waters and seasonal stratification of the water column.

### REFERENCES

All publications mentioned herein are incorporated herein by reference (where permitted) to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.
Alberta Environment, 2008. Guideline for wetland establishment on reclaimed oil sands leases (2nd edition). Prepared by M L Harris (Lorax Environmental) for the Wetlands and Aquatics Subgroup (WASG) of the Cumulative Environmental Management Association (CEMA), Fort McMurray, AB, December 2007.
Bataineh M, Scott A C, Fedorak P M, Martin J W, 2006. Capillary HPLC/QTOF-MS for characterizing complex naphthenic acid mixtures and their microbial transformation. Analytical Chemistry 78: 8354-8361.
Boerger H, Aleksiuk M, 1985. Natural detoxification and colonization of oil sands tailings water in experimental pits. In: Vandermeulen J H (ed.). Oil in Freshwater: Proceedings of an International Conference, held Oct. 15-18, 1984 in Edmonton, AB.
Boerger H, MacKinnon M, Aleksiuk M, 1986. Use of toxicity tests in studies of oil sands tailings water detoxification, In: Green G H (ed). Proceedings of the 11th Annual Toxicity Workshop, held Nov. 13-15, 1984 in Vancouver, BC. Canadian Technical Report of Fisheries and Aquatic Sciences No. 14580: pp 131-146.
Boerger H, MacKinnon M, Hunter B, 1990, Oil sands clay fines: can they be reclaimed as productive, self-sustaining wetlands? Presented at the Canadian Land Reclamation Association Annual General Meeting, held Sep. 19, 1990 in Fort McMurray, AB.
Boerger H, MacKinnon M, Van Meer T, 1992. Wet landscape option for reclamation of oils sand fine tails. In: Singhal R K, Mehrotra A K, Fytas K, Collins J-L (eds.). Proceedings of the Second International Conference on Environmental Issues and Management of Waste in Energy and Mineral Production, held Sep. 1-4, 1992 in Calgary, AB.
Boyd T J, Montgomery M T, Steele J K, Pohlman J W, Reatherford S R, Spargo B J, Smith D C, 2005. Dissolved oxygen saturation controls PAH biodegradation in freshwater estuary sediments. Microbial Ecology 49: 226-235.
Brady V J, Cardinale B J, Gathman J P, Burton T M, 2002. Does facilitation of faunal recruitment benefit ecosystem restoration? An experimental study of invertebrate assemblages in wetland mesocosms. Restoration Ecology 10(4): 617-626.
Burkhard L P, Lukasewycz M T, 2000. Some bioaccumulation factors and biota-sediment accumulation factors for polycyclic aromatic hydrocarbons in lake trout. Environmental Toxicology and Chemistry 19(5): 1427-1429.
Burton D, Burton M P, Idler D R, 1984. Epidermal conditions in post spawned winter flounder, Pseudopleuronectes americanus (Walbaum), maintained in the laboratory and after exposure to crude petroleum. Journal of Fish Biology 25: 593-606.
Canadian Council of Ministers of the Environment (CCME), 2009. Canadian water quality guidelines for the protection of aquatic life. In: Canadian Environmental Quality Guidelines, CCME, Winnipeg, MB. Available online at http://ceqg-rcqe.ccme.ca/
Clemente J S, Yen T-W, Fedorak P M, 2003. Development of a high performance liquid chromatography method to monitor the biodegradation of naphthenic acids. Journal of Environmental Engineering and Science 2: 177-186.
Clemente J S, MacKinnon M D, Fedorak P M, 2004. Aerobic biodegradation of two commercial naphthenic acids preparations. Environmental Science and Technology 38(4): 1009-1016.
Clemente J S, Fedorak P M, 2005. A review of the occurrence, analyses, toxicity, and biodegradation of naphthenic acids. Chemosphere 60(5): 585-600.
CONRAD Environmental Aquatics Technical Advisory Group (CEATAG), 1998. Naphthenic acids background information discussion report. June 1998.
Cooper D, Wolf E, Gage E, 2007. Plant establishment for wetland reclamation: a review of plant establishment techniques and species tolerances for water level and salinity. Appendix D In: Harris M L, 2007. Guideline for wetland establishment on reclaimed oil sands leases. Revised (2007) edition, Prepared for Cumulative Environmental Management Association (CEMA), Wetlands and Aquatics Subgroup (WASG).
Crusius J, Pieters R, Leung A, Whittle P, Pedersen T, Lawrence G, McNee J J, 2002. Tale of two pit lakes: initial results of a three-year study of the Maine Zone and Waterline pit lakes near Houston, British Columbia, Canada. Preprint number 02-129 presented at SME Annual Meeting, Feb. 25-27, Phoenix, Ariz.,
Danielson L J, MacKinnon M D, 1990. Rheological properties of Syncrude's tailings pond sludge. AOSTRA Journal of Research 6(1990): 99-121.
Del Rio L F, Hadwin A K M, Pinto L J, MacKinnon M D, Moore M M, 2006. Degradation of naphthenic acids by sediment micro-organisms. Journal of Applied Microbiology 101(5): 1049-1061.
Eckert W F, Masliyah J H, Gray M R, Fedorak P M, 1996. Prediction of sedimentation and consolidation of fine tails. AICHE Journal 42: 960-972.
End Pit Lakes Working Group, 2002. Guidelines for lake development at coal mine operations in mountain foothills of the northern east slopes. Report prepared for Alberta Environment, Environmental Service Division, Edmonton, AB. Report #ESD/LM/00-1.
Farwell A J, Nero V, Croft M, Rhodes S, Dixon D G, 2006. Phototoxicity of oil sands-derived polycyclic aromatic compounds to Japanese medaka (Oryzias latipes) embryos. Environmental Toxicology and Chemistry 25(12): 3266-3274.
Fedorak P M, Coy D L, Dudas M J, Simpson M J, Renneberg A J, MacKinnon M D, 2003. Microbially-mediated fugitive gas production from oil sands tailings and increased tailings densification rates. Journal of Environmental Engineering 2(3): 199-211.
Gentes M L, Waldner C, Papp Z, Smits J E G, 2005. Effects of oil sands tailings compounds and harsh weather on mortality rates, growth and detoxification efforts in nestling tree swallows (Tachycineta bicolor). Environmental Pollution 142(1): 24-33.
Gentes M L, Whitworth T L, Waldner C, Fenton H, Smits J E, 2007a. Tree swallows (Tachycineta bicolor) nesting on wetlands impacted by oil sands mining are highly parasitized by the bird blow fly Protocalliphora spp. Journal of Wildlife Diseases 43(2): 167-178.
Gentes M L, Waldner C, Papp Z, Smits J E G, 2007b. Effects of exposure to naphthenic acids in tree swallows (Tachycineta bicolor) on the Athabasca oil sands, Alberta, Canada. Journal of Toxicology and Environmental Health Part A—Current Issues 70(13-14): 1182-1190.
Gulley J R, MacKinnon M, 1993. Fine tails reclamation utilizing a wet landscape approach. Proceedings of the AOSTRA Conference “Oil Sands—Our Petroleum Future”, held Apr. 4-7, 1993 in Edmonton, AB.

Guo C, Chalaturnyk R J, Scott J D, MacKinnon M, Cyre G, 2002. Geotechnical field investigation of the rapid densification phenomenon in oil sands mature fine tailings. Fifty-fifth Canadian Geotechnical Conference, held Oct. 20-23, 2002 in Niagara Falls, ON.
Guo C, Chalaturnyk R J, Scott J D, MacKinnon M, 2004. Densification of oil sands tailings by biological activity. Proceedings of the 57th Canadian Geotechnical Conference, held October, 2004 in Quebec City, QC.
Guo C, Chalaturnyk R J, Scott J D, MacKinnon M, 2007. Effect of biological gas generation on oil sand fine tailings. Coal and Oil Sands Paper 31 (September/October), CIM Bulletin 100(1104): 1-7.
Hadwin A K M, Del Rio L F, Pinto L J, Painter M, Routledge R, Moore M M, 2006. Microbial communities in wetlands of the Athabasca oil sands: genetic and metabolic characterization. FEMS Microbiology Ecology 55(1): 68-78.
Han X, Scott A C, Fedorak P M, Bataineh M, Martin J W, 2008. Influence of molecular structure on the biodegradability of naphthenic acids. Environmental Science and Technology 42(4): 1290-1295.
Harris M L, 2007. Design elements for wildlife habitat. Section 5 In: Draft revised Guidelines for reclamation to forest vegetation in the Athabasca oil sands region. Prepared for Cumulative Environmental Management Association (CEMA), Biodiversity and Wildlife Subgroup of the Reclamation Working Group, Fort McMurray, AB.
Herman D C, Fedorak P M, MacKinnon M D, Costerton J W, 1992. An investigation of the potential for in situ bioremediation of oil sands tailings. In: Baddaloo E (ed.). Proceedings of the 19th Annual Aquatic Toxicity Workshop, held Oct. 4-7, 1992 in Edmonton, AB.
Herman D C, Fedorak P M, MacKinnon M D, Costerton J W, 1994. Biodegradation of naphthenic acids by microbial populations indigenous to oil sands tailings. Canadian Journal of Microbiology 40(6): 467-477.
Holowenko F M, MacKinnon M D, Fedorak P M, 2000. Methanogens and sulfate-reducing bacteria in oil sands fine tailings waste. Canadian Journal of Microbiology 46: 927-937.
Holowenko F M, MacKinnon M D, Fedorak P M, 2001. Naphthenic acids and surrogate naphthenic acids in methanogenic microcosms. Water Research 35(11): 2595-2606.
Holowenko F M, MacKinnon M D, Fedorak P M, 2002. Characterization of naphthenic acids in oil sands wastewater by gas chromatography—mass spectrometry. Water Research 36: 2843-2855.
Kavanagh R, Frank R, Farwell A, Dixon G, MacKinnon M, Van Der Kraak G, 2006. The effects of oil sands constituents on fathead minnow (Pimephales promelas) reproduction. Presented at the 2006 Aquatic Toxicity Workshop.
Kelly E N, Short J W, Schindler D W, Hodson P V, Ma M, Kwan A K, Fortin B L, 2009. Oil sands development contributes polycyclic aromatic compounds to the Athabasca River and its tributaries. Proceedings of the National Academy of Sciences of the USA 106(52): 22346-22351.
Lawrence G A, Ward P R B, MacKinnon M D, 1991. Wind-wave-induced suspension of mine tailings in disposal ponds—a case study. Canadian Journal of Civil Engineering 18(6): 1047-1053.
Leung S S-C, MacKinnon M D, Smith R E H, 2001. Aquatic reclamation in the Athabasca, Canada, oil sands: Naphthenate and salt effects on phytoplankton communities. Environmental Toxicology and Chemistry 20(7): 1532-1543.
Leung S S, MacKinnon M D, Smith R E H, 2003. The ecological effects of naphthenic acids and salts on phytoplankton from the Athabasca oil sands region. Aquatic Toxicology 62(1): 11-26.
Lieffers V J, 1984. Emergent plant communities of oxbow lakes in north eastern Alberta: salinity, water-level fluctuations, and succession. Canadian Journal of Botany 62: 310-316,
Lieffers V J, Shay J M, 1983. Ephemeral saline lakes on the Canadian prairies: their classification and management for emergent macrophyte growth. Hydrobiologia 105: 85-94.
Lister A, Nero V, Farwell A, Dixon D G, Van Der Kraak G, 2008. Reproductive and stress hormone levels in goldfish (Carassius auratus) exposed to oil sands process-affected water. Aquatic Toxicology 87: 170-177.
MacKinnon M D, 1989. Development of the tailings pond at Syncrude's oil sands plant: 1978-1987. AOSTRA Journal of Research 5: 109-133.
MacKinnon M D, Retallack J T, 1981. Preliminary characterization and detoxification of tailings pond water at the Syncrude Canada Ltd. oil sands plant. In: Land and Water Issues Related to Energy Development (Rand P J, ed). Proceedings of the 4th Annual Meeting of the Internation Society of Petroleum Industry Biologists, Denver, Colo.
MacKinnon M D, Boerger H, 1986. Description of two treatment methods for detoxifying oil sands tailings pond water. Water Pollution Research Journal of Canada 21(4): 496-512.
MacKinnon M, Boerger H, 1991, Assessment of a wet landscape option for disposal of fine tails sludge from oil sands processing. Proceedings of the Petroleum Society of CIM and AOSTRA Technical Conference, held Apr. 21-24, 1991 in Banff.
Madill R E A, Brownlee B G, Josephy P D, Bunce N J, 1999. Comparison of the Ames Salmonella assay and Mutatox genotoxicity assay for assessing the mutagenicity of polycyclic aromatic compounds in porewater from Athabasca oil sands mature fine tailings. Environmental Science and Technology 33(15): 2510-2516.
Madill R E A, Orzechowski M T, Chen G, Brownlee B G, Bunce N J, 2001. Preliminary risk assessment of the wet landscape option for reclamation of oil sands mine tailings: bioassays with mature fine tailings pore water. Environmental Toxicology 16(3): 197-208.
Merlin M, Guigard S E, Fedorak P M, 2007. Detecting naphthenic acids in waters by gas chromatography—mass spectrometry. Journal of Chromatography A 1140: 225-229.
Mikula R J, Kasperski K L, Burns R D, MacKinnon M D, 1996. Nature and fate of oil sands fine tailings. In: Schramm L L (ed). Suspensions: Fundamentals and Applications in the Petroleum Industry. American Chemical Society (ACS) Advances in Chemistry Series 251. ACS, Washington, D.C.
Moe S J, Dudley B, Ptacnik R, 2008. REBECCA databases: experiences from compilation and analyses of monitoring data from 5,000 lakes in 20 European countries. Aquatic Ecology 42: 183-201.
Murchie K J, Power M, 2004. Growth- and feeding-related isotopic dilution and enrichment patterns in young-of-the-year yellow perch (Perca flavescens). Freshwater Biology 49(1): 41-54.
Myers M S, Johnson L L, Horn T, Collier T K, Stein J E, Varanasi U, 1998. Toxicopathic hepatic lesions in subadult English sole (Pleuronectes vetulus) from Puget Sound, Wash., USA: relationships with other biomarkers of contaminant exposure. Marine Environmental Research 45: 47-67.
Nero V, Farwell A, Lee L E J, Van Meer T, MacKinnon M D, Dixon D G, 2006a. The effects of salinity on naphthenic acid toxicity to yellow perch: Gill and liver histopathology. Ecotoxicology and Environmental Safety 65(2): 252-264.
Nero V, Farwell A, Lister A, Van Der Kraak G, Lee L E J, Van Meer T, MacKinnon M D, Dixon D G, 2006b. Gill and liver histopathological changes in yellow perch (Perca flavescens) and goldfish (Carassius auratus) exposed to oil sands process-affected water, Ecotoxicology and Environmental Safety 63(3): 365-377.
Norberg M, Bigler C, Renberg I, 2008. Monitoring compared with paleolimnology: implications for the definition of reference condition in limed lakes in Sweden. Environmental Monitoring and Assessment 146: 295-308.
Peters L E, MacKinnon M, Van Meer T, van den Heuvel M R, Dixon D G, 2007. Effects of oil sands process-affected waters and naphthenic acids on yellow perch (Perca flavescens) and Japanese medaka (Oryzias latipes) embryonic development. Chemosphere 67(11): 2177-2183.
Purdy B G, Macdonald S E, Lieffers V J, 2005. Naturally saline boreal communities as models for reclamation of saline oil sand tailings. Restoration Ecology 13(4): 667-677.
Quagraine E K, Headley J V, Peterson H G, 2005. Is biodegradation of bitumen a source of recalcitrant naphthenic acid mixtures in oil sands tailing pond waters? Journal of Environmental Science and Health Part A—Toxic/Hazardous Substances & Environmental Engineering 40(3): 671-684.
Quagraine E K, Peterson H G, Headley J V, 2005. In situ bioremediation of naphthenic acids contaminated tailing pond waters in the Athabasca oil sands region—demonstrated field studies and plausible options: A review. Journal of Environmental Science and Health Part A—Toxic/Hazardous Substances & Environmental Engineering 40(3): 685-722.
Rhodes S, Farwell A, Hewitt L M, MacKinnon M, Dixon D G, 2005. The effects of dimethylated and alkylated polycyclic aromatic hydrocarbons on the embryonic development of the Japanese medaka. Ecotoxicology and Environmental Safety 60(3): 247-258.
Rogers V, MacKinnon M, Brownlee B, 2007. Analytical approaches to characterizing fish tainting potential of oil sands process waters. Water Science & Technology 55(5): 311-318.
Rogers V V, Liber K, MacKinnon M D, 2002. Isolation and characterization of naphthenic acids from Athabasca oil sands tailings pond water. Chemosphere 48: 519-527.
Salloum M J, Dudas M J, Fedorak P M, 2002. Microbial reduction of amended sulfate in anaerobic mature fine tailings from oil sand. Waste Management Research 20: 162-171.
Scott A C, MacKinnon M D, Fedorak P M, 2005. Naphthenic acids in Athabasca oil sands tailings waters are less biodegradable than commercial naphthenic acids. Environmental Science and Technology 39(21): 8388-8394,
Siddique T, Fedorak P M, Foght J M, 2006. Biodegradation of short-chain n-alkanes in oil sands tailings under methanogenic conditions. Environmental Science and Technology 40(17): 5459-5464.
Siddique T, Fedorak P M, MacKinnon M D, Foght J M, 2007. Metabolism of BTEX and naphtha compounds to methane in oil sands tailings. Environmental Science and Technology 41(7): 2350-2356.
Siwik P L, Van Meer T, MacKinnon M D, Paszkowski C A, 2000. Growth of fathead minnows in oilsand-processed wastewater in laboratory and field. Environmental Toxicology and Chemistry 19(7): 1837-1845.
Smits J E, Wayland M E, Miller M J, Liber K, Trudeau S, 2000. Reproductive, immune, and physiological end points in tree swallows on reclaimed oil sands mine sites. Environmental Toxicology and Chemistry 19(12): 2951-2960.
Spies R B, Stegeman J J, Hinton D E, Woodin B, Smolowitz R, Okihiro M, Shea D, 1996. Biomarkers of hydrocarbon exposure and sublethal effects in embiotocid fishes from a natural petroleum seep in the Santa Barbara Channel. Aquatic Toxicology 34: 195-219.
Sumer S, Pitts L, McCullouch J, Quan H, 1995. Alberta lake re-established after draining to mine coal. Mining Engineering November 1995: 1016-1019.
Tetreault G R, McMaster M E, Dixon D G, Parrott J L, 2003. Physiological and biochemical responses of Ontario slimy sculpin (Cottus cognatus) to sediment from the Athabasca Oil Sands area. Water Quality Research Journal of Canada 38(2): 361-377.
Tetreault G R, McMaster M E, Dixon D G, Parrott J L, 2003. Using reproductive endpoints in small forage fish species to evaluate the effects of Athabasca oil sands activities. Environmental Toxicology and Chemistry 22(11): 2775-2782.
van den Heuvel M R, Power M, MacKinnon M D, Van Meer T, Dobson E P, Dixon D G, 1999a. Effects of oil sands related aquatic reclamation on yellow perch (Perca flavescens), I. Water quality characteristics and yellow perch physiological and population responses. Canadian Journal of Fisheries and Aquatic Sciences 56(7): 1213-1225.
van den Heuvel M R, Power M, MacKinnon M D, Dixon D G, 1999b. Effects of oil sands related aquatic reclamation on yellow perch (Perca flavescens). II. Chemical and biochemical indicators of exposure to oil sands related waters. Canadian Journal of Fisheries and Aquatic Sciences 56(7): 1226-1233.
van den Heuvel M R, Power M, Richards J, MacKinnon M, Dixon D G, 2000. Disease and gill lesions in yellow perch (Perca flavescens) exposed to oil sands mining-associated waters. Ecotoxicology and Environmental Safety 46(3): 334-341.
Ward P R B, Lawrence G A, MacKinnon M D, 1994. Wind driven resuspension of sediment in a large tailings pond. Proceedings of International Symposium on Ecology and Engineering, held Oct. 29-Nov. 3, 1994, Malaysia.
Watson J S, Jones D M, Swannell R P J, van Duin A C T, 2002. Formation of carboxylic acids during aerobic biodegradation of crude oil and evidence of microbial oxidation of hopanes, Organic Geochemistry 33: 1153-1169.
Wayland M, Headley J V, Peru K M, Crosley R, Brownlee B G, 2008. Levels of polycyclic aromatic hydrocarbons and dibenzothiophenes in wetland sediments and aquatic insects in the oil sands area of Northeastern Alberta, Canada. Environmental Monitoring and Assessment 136: 167-182.
Yong R N, Siu S K H, Sheeran D E. 1983. On the stability and settling of suspended solids in settling ponds. Part I. Piece-wise linear consolidation analysis of sediment layer. Canadian Geotechnology Journal 20: 817
Young R F, Orr E A, Goss G G, Fedorak P M, 2007. Detection of naphthenic acids in fish exposed to commercial naphthenic acids and oil sands process-affected water, Chemosphere 68(3): 518-527.
Young R F, Wismer W V, Fedorak P M, 2008. Estimating naphthenic acids concentrations in laboratory-exposed fish and in fish from the wild. Chemosphere 73:498-505.

What is claimed is:

1. A method of reclamation using tailings produced during oil sands extraction processes comprising:
a) depositing tailings below grade into a pit, the tailings comprising a solids content of at least about 30 wt % with greater than about 60% of the solids comprising fines;
b) placing a layer of water of sufficient depth and volume over the deposit of tailings; and
c) allowing densification of the tailings to occur without mechanical or chemical intervention, wherein the layer of water capping the tailings deposit forms a lake habitable for plants and animals.

2. The method of claim 1, wherein the ratio of tailings to water is greater than about 4.0 (v/v).

3. The method of claim 2, wherein the volume of the water layer ranges from about 35×10⁶ m³ to about 40×10⁶ m³.

4. The method of claim 2, wherein the volume of the tailings is greater than about 175×10⁶ m³.

5. The method of claim 2, wherein the total volume of tailings and water in the lake ranges from about 2,000 m³ to about 140,000 m³.

6. The method of claim 2, wherein the depth of the water layer is equal to or greater than about 5 meters.

7. The method of claim 6, wherein the fetch is less than about 4 km.

8. The method of claim 1, wherein the tailings comprises fluid fine tailings (FFT).

9. The method of claim 1, wherein the water comprises natural surface water or oil sands process-affected water.

10. The method of claim 9, wherein the natural surface water is selected from muskeg drainage or surface runoff water.

11. The method of claim 1, wherein the end-pit is lined by a clay substrate.

12. The method of claim 1, wherein pore water released from the tailings into the water layer comprises a napthenic acid concentration between about 50 mg/L to about 90 mg/L.

13. The method of claim 12, wherein the pore water has a polycyclic aromatic hydrocarbon concentration less than about 1.0 μg/L to about 3.0 μg/L.

14. The method of claim 13, wherein the pore water has a bitumen content between about 1.5 wt % to about 5.0 wt %.

15. The method of claim 1, further comprising the step of skimming floatable material from the water layer capping the tailings deposit.

16. The method of claim 15, wherein the floatable material comprises bitumen, a hydrocarbon sheen, an oil film, fine mineral solids, a foam, an emulsion, or debris.

17. The method of claim 16, wherein skimming is conducted using a modified barge positioned within the water layer and comprising:
i) a floating platform;
ii) a bottom plate;
iii) a pair of weir plates extending upwardingly from the bottom plate to define a pump chamber;
iv) a submersible pump extending from the platform downwardly into the chamber; and
v) screens separating the pump chamber from the weir plates, the screens and the weir plates defining a second chamber housing an air bubbler.

18. The method of claim 17, wherein the weir plates extend upwardly to a height above the screens to allow the flow of the water layer and floatable material over the weir plates into the second chamber.

19. The method of claim 17, wherein the screens are removable by corresponding pulleys.

20. The method of claim 17, wherein one or more of the bottom plate and the weir plates are formed of steel.

21. The method of claim 17, comprising activating the air bubbler to generate a continuous flow of fine air bubbles for attachment to the floatable material.

22. The method of claim 21, wherein removal of bitumen is conducted using a surface suction intake.

23. The method of claim 22, comprising pumping the water using the pump through the screens from the second chamber into the pump chamber.

24. The method of claim 23, wherein the water is pumped upwardly out of the pump chamber and directed to a processing plant or a holding tank.

25. The method of claim 16, wherein skimming is conducted using a barge equipped with a submersible pump and an air bubbler positioned within the water layer capping the tailings deposit.

26. The method of claim 25, wherein the tailings pond proximate to the barge is equipped with a weir which extends upwardly from the base of the tailings pond to a height above the surface of the water layer to allow the flow of water and floatable material over the weir.

27. The method of claim 26, wherein the air bubbler is activated to generate a continuous flow of fine air bubbles for attachment to the floatable material.

28. The method of claim 27, wherein removal of bitumen is conducted using a surface suction intake.

29. The method of claim 28, wherein the water is pumped upwardly using the pump and directed to a processing plant or a holding tank.

30. The method of claim 1, wherein the tailings comprise tailings that have been first subjected to centrifugation, filtration, gravity separation, or accelerated dewatering in a dewatering pit.
